(19) United States
(12) Patent Application Publication
(10) Pub. No.: US 2015/0008633 A1
(43) Pub. Date: Jan. 8, 2015

(54) Holder For A Sheet Of Metal

(71) Applicant: Gainteam Holdings Limited, New Territories (HK)

(72) Inventors: Howard Ho Yin CHAN, Hong Kong (HK); Chung Yin AU, Hong Kong (HK); Wan Hong BAO, Guangdong (CN); Zhen Qi LI, Henan (CN); Hua Hai ZHAI, Jiangxi (CN); Bai Jun LI, Liaoning (CN); Yi CAO, Human (CN)

(73) Assignee: Gainteam Holdings Limited, New Territories (HK)

(21) Appl. No.: 14/038,897

(22) Filed: Sep. 27, 2013

(30) Foreign Application Priority Data
Sep. 27, 2012 (HK) HK12109548.4

(51) Int. Cl. B26D 7/01; B21D 33/00

(52) U.S. Cl. CPC B26D 7/015; B21D 33/00
USPC 269/287

(57) ABSTRACT

A holder (13, 13a, 13b, 13c, 13d) for holding a sheet of metal (36) is disclosed which includes a base (40) for engaging with part of a first major surface (38b) of the sheet of metal (36) and a cover (50) for engaging with part of a second major surface (38a) of the sheet of metal (36). The base (40) and the cover (50) are engageable with each other to hold the sheet of metal (36) therebetween.

### CROSS REFERENCE TO RELATED APPLICATIONS

This application claims priority in Hong Kong Patent Application no. 12109548.4, filed 27 Sep. 2012, the contents of which are hereby incorporated by reference.

### TECHNICAL FIELD

This invention relates to a holder for a sheet of metal, in particular such a holder suitable for holding at least a sheet of metal for metalworking, such as metal forming in a fully-automated or semi-automated metal forming system.

### BACKGROUND

Metalworking includes forming, cutting and joining of metals. Forming processes are carried out to modify metal or workpiece (e.g. a sheet of metal) by deforming the object, i.e. without removing any material. Forming is done with heat and pressure, and/or with mechanical force, or all of them. In some of the steps in existing methods and systems for forming metals, such as stamping of sheets of metal (e.g. copper foils of a thickness of around 0.1 mm, aluminum foils of a thickness of around 2 mm, or a sheet of stainless sheet), the sheets of metal have to be directly held and thus contacted by workers, so that the sheets of metal are susceptible to contamination. This also prevents full automation of metal forming methods or systems.

### SUMMARY OF THE INVENTION

It is thus an object of the present invention to provide a holder for a sheet of metal in which the aforesaid shortcomings are mitigated or at least to provide a useful alternative to the trade and public. By using a holder according to the present invention, human contact with the sheets of metal can be avoided, so that contamination of the sheets of metal is minimized, and metal forming methods or systems may be fully automated. In addition, using a holder according to the present invention also enhances efficiency of the metal forming process and facilitates precise position of the sheet of metal for the metal forming process.

According to the present invention, there is provided a holder for holding at least one sheet of metal, said holder including a first holder member adapted to engage with part of a first major surface of a sheet of metal, a second holder member adapted to engage with part of a second major surface of said sheet of metal, and a device for fixedly securing said first holder member with said second holder member, wherein said first holder member and said second holder member are engageable with each other to hold said sheet of metal there-between, and wherein said securing device includes a first part engaged with said first holder member and a second part engaged with said second holder member.

### BRIEF DESCRIPTION OF THE DRAWINGS

A holder for holding at least one sheet of metal according to an embodiment of the present invention will now be described, by way of an example only, with reference to the accompany drawings, in which:

FIG. 1A is a top perspective view of a machine for loading a sheet of metal into a holder according to the present invention, for a metal forming process;

FIG. 1B is a front view of the machine shown in FIG. 1A;

FIG. 1C is a right side view of the machine shown in FIG. 1A;

FIG. 1D is a left side view of the machine shown in FIG. 1A;

FIG. 1E is a rear view of the machine shown in FIG. 1A;

FIG. 1F is a rear perspective view of the machine shown in FIG. 1A with part of the outer casing removed for clarity purpose;

FIG. 2A is a front perspective view of a carrier used in the machine shown in FIG. 1A, in which only one holder according to the present invention is carried and with a side door opened;

FIG. 2B is a rear perspective view of the carrier shown in FIG. 2A, fully loaded with holders;

FIG. 2C is a front perspective of the carrier of FIG. 2B;

FIG. 2D is a bottom view of the carrier of FIG. 2B;

FIG. 2E is a bottom perspective view of the carrier of FIG. 2B;

FIG. 2F is a further front perspective view of the carrier of FIG. 2B, with the top of the carrier removed;

FIG. 2G is an enlarged bottom perspective view of the carrier of FIG. 2E;

FIG. 3 is a perspective view of a sheet of metal to be loaded into the holder by the machine shown in FIG. 1A;

FIG. 4A is a perspective view of the holder shown as being carried in the carrier of FIG. 2A in a detached configuration;

FIG. 4B is a perspective sectional view of the holder of FIG. 4A;

FIG. 4C is an enlarged perspective sectional view of the holder of FIG. 4B;

FIG. 5A is a perspective sectional view of the holder of FIG. 4A in an engaged and locked configuration;

FIG. 5B is an enlarged perspective sectional view of the holder of FIG. 5A;

FIG. 6A is a perspective sectional view of the holder of FIG. 5A in an engaged and unlocked configuration;

FIG. 6B is an enlarged perspective sectional view of the holder of FIG. 6A;

FIG. 7 is a top perspective view of a metal forming machine in which the holder according to the present invention is used;

FIG. 8 is a further top perspective view of the machine shown in FIG. 7, with part of the outer cover removed;

FIG. 9 is another top perspective view of the machine shown in FIG. 7;

FIG. 10 is a perspective view of part of the machine shown in FIG. 9;

FIG. 11A is a top perspective view of the sheet of metal as held by the holder and acted on by a stamping head;

FIG. 11B is a further top perspective view of the sheet of metal as held by the holder and acted on by the stamping head;

FIG. 11C is a top view of the sheet of metal as held by the holder and acted on by the stamping head;

FIG. 11D is a top perspective view of the stamping head shown in FIG. 11A;

FIG. 11E is a bottom perspective view of the stamping head shown in FIG. 11A;

FIG. 11F is a side view of the stamping head shown in FIG. 11A;

FIG. 12A is a top perspective view of the die of the stamping head shown in FIG. 11A;

FIG. 12B is a bottom perspective view of die shown in FIG. 12A;

FIG. 13 is a top perspective view of the sheet of metal as acted by a lower part of the stamping head shown in FIG. 11A;

FIG. 14 is a top perspective view of the sheet of metal as acted on by an abutment member of the stamping head shown in FIG. 13;

FIG. 15A is a top perspective view of the abutment member of the stamping head shown in FIG. 14; and

FIG. 15B is a bottom perspective view of the abutment member shown in FIG. 15A.

### DETAILED DESCRIPTION OF THE INVENTION

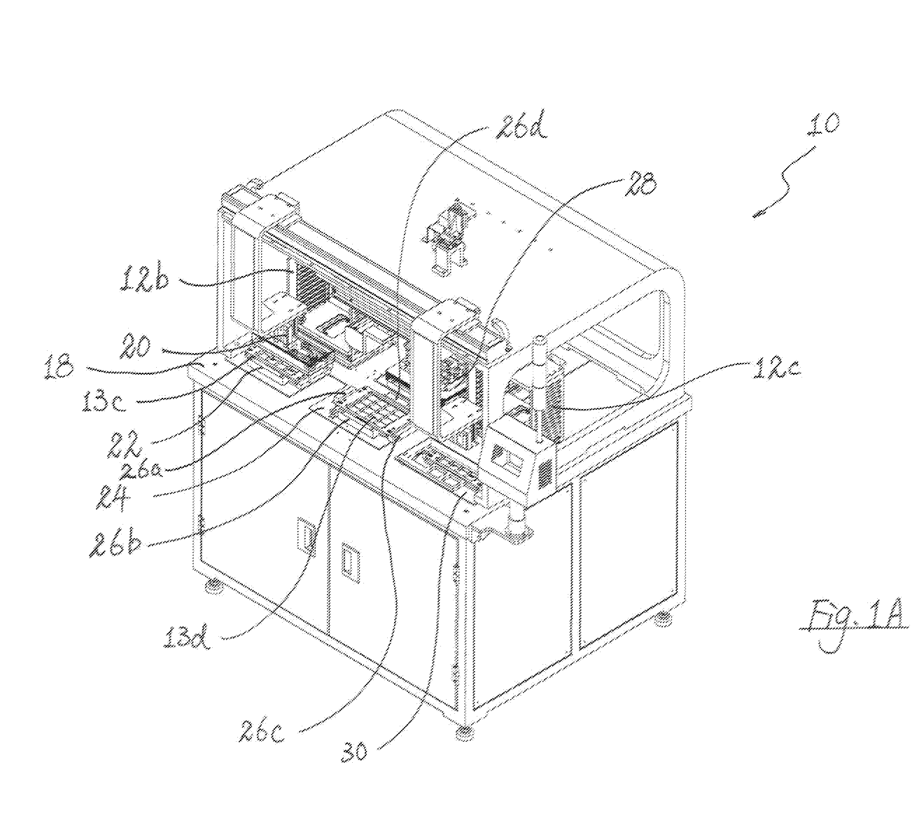

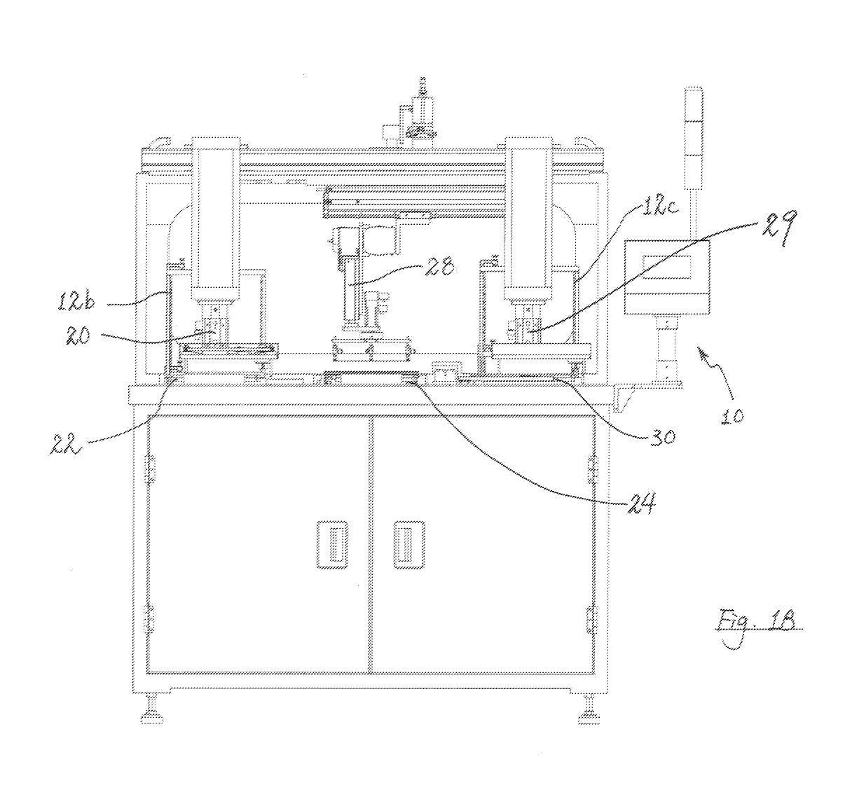

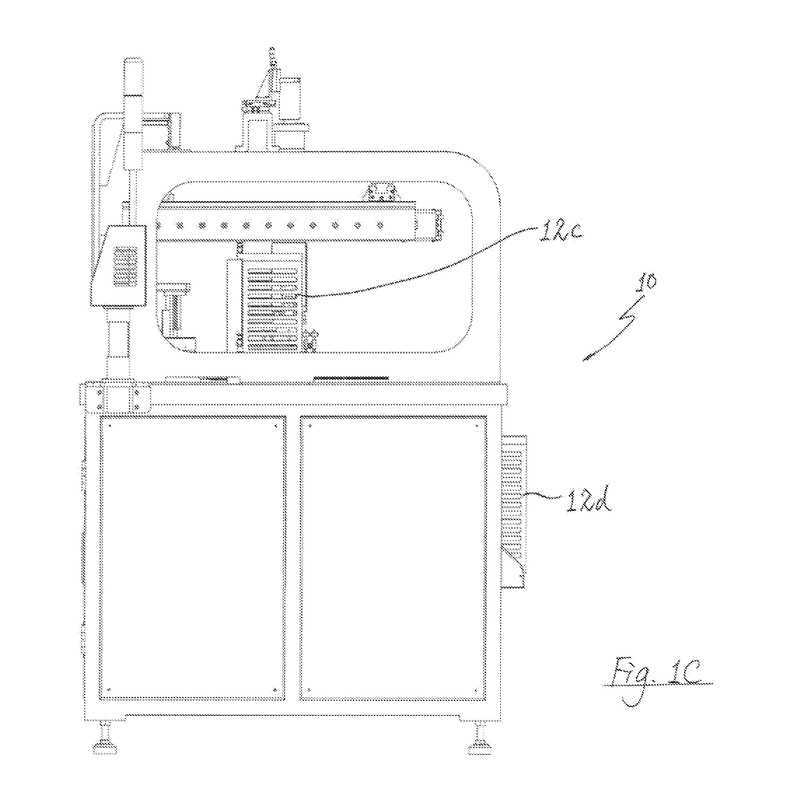

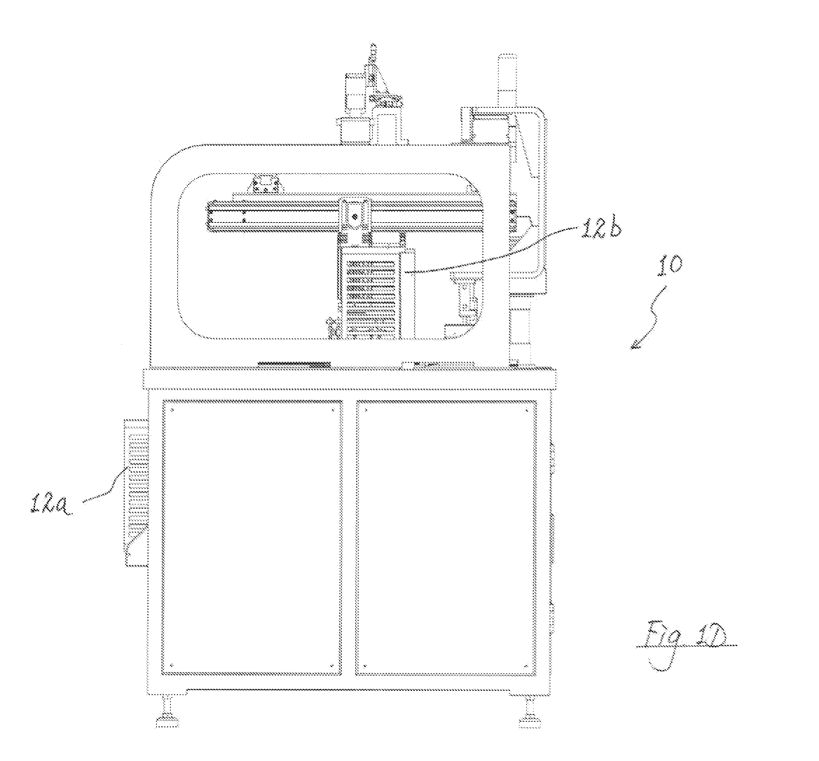

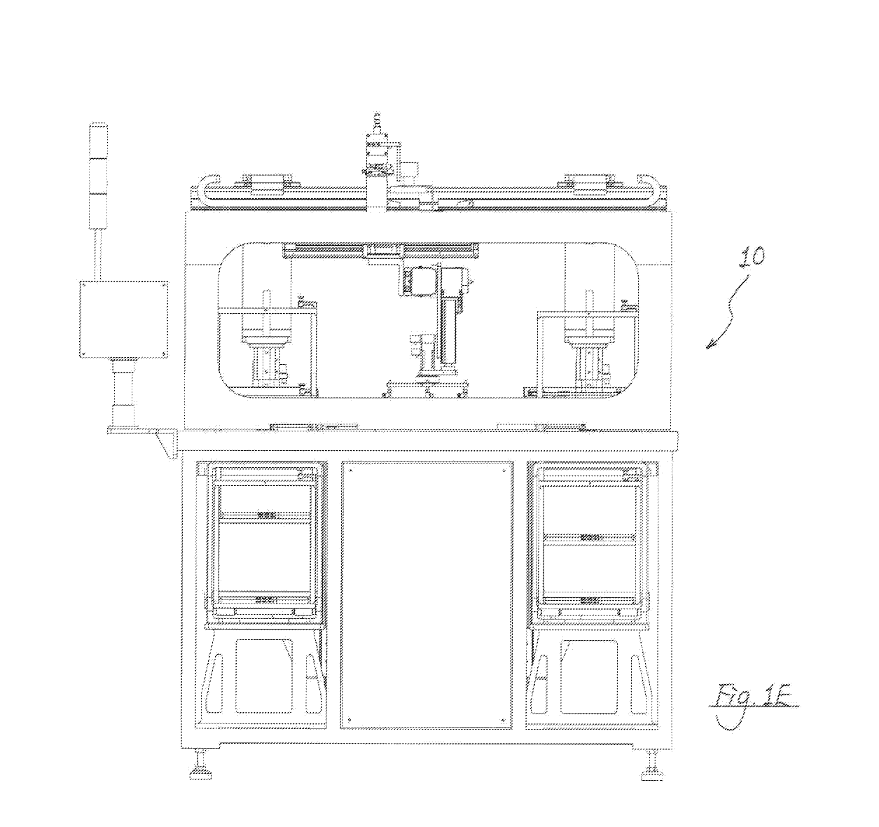

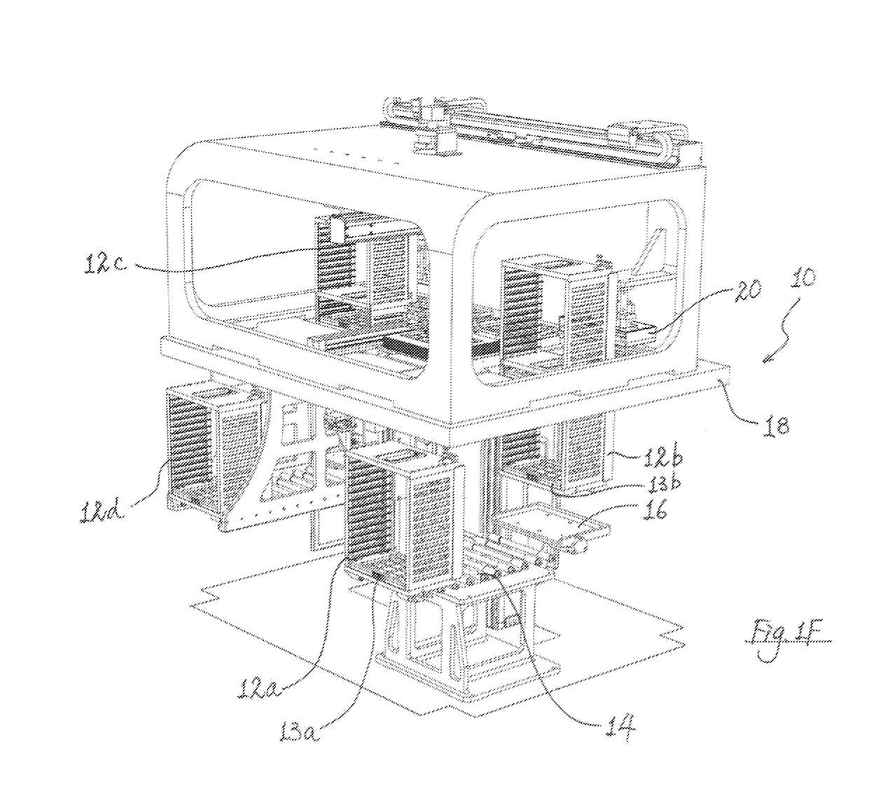

Referring firstly to FIGS. 1A to 1F, a machine for loading a workpiece (in particular, a sheet of metal) into a holder is shown, and generally designated as 10. Broadly stated, the loading machine 10 has (a) a mechanism for conveying unloaded holders (to be further discussed below) to a loading position, (b) a mechanism for loading a workpiece into the unloaded holder at the loading position and (c) a mechanism for conveying the loaded holders away from the loading position.

Locked holders are carried and conveyed by carriers 12a, 12b, 12c, 12d, in which the holders are stacked one above another. In FIG. 1F, one locked unloaded holder 13a is shown as being held in the carrier 12a. The carrier 12a is then conveyed by a roller system 14 to a position adjacent a platform 16 whereby unloaded holders in the carrier 12a are conveyed to the carrier 12b when the carrier 12b rests on the platform 16. Upon receipt of the unloaded holders 13b, the carrier 12b is then raised intermittently vertically through an aperture in a working table 18 of the machine 10 to raise the unloaded holders one by one consecutively through the aperture to a pre-determined level above the working table 18. Each unloaded holder (when such is raised to the working level above the working table 18) is then moved to a first working platform 22.

FIG. 1A shows an unloaded holder 13c resting on the first working platform 22. A first robot arm 20 then picks up (e.g. by a number of claws) the holder 13c and places it on a second working platform 24. A holder 13d is shown in FIG. 1A as being placed on the second working platform 24. Four blocks 26a, 26b, 26c, 26d extend above the working table 18. Of these four blocks 26a, 26b, 26c, 26d, the blocks 26c, 26d are perpendicular to each other and are fixed relative to the working table 18; the blocks 26b, 26c are perpendicular to each other; and the blocks 26a, 26b are perpendicular to each other and are movable up and down to ensure proper positioning of the holder 13d on the second working platform 24, and within the confines of the blocks 26a, 26b, 26c, 26d.

When the locked holder 13d (which is formed of a cover and a base, and to be further discussed below) is on the second working platform 24, the locked holder 13d is un-locked, allowing the cover to be released and detached from the base. The first robot arm 20 then picks up (e.g. by a number of claws) the cover. A second robot arm 28 then picks up (e.g. by suction) a sheet of metal, such as a copper foil (which may of a thickness of around 0.1 mm), an aluminum foil (which may be of a thickness of around 2 mm) or a stainless steel sheet, and places it on the base of the holder 13d. When the sheet of metal is properly positioned on the base of the holder 13d, the first robot arm 20 then places the cover back on to the base (thus engaging the sheet of metal in between). When the positioning of the sheet of metal 36 is found by a camera to be correct and the cover 50 and the base 40 are found to be properly aligned with each other, the holder 13d is then locked again to securely hold the sheet of metal 36. A third robot arm 29 (see FIG. 1B) then moves the locked and loaded holder from the second working platform 24 to the third working platform 30. A locked and loaded holder 13d is shown in FIG. 1A as being placed on the third working platform 30.

The locked and loaded holder 13d is then pushed into a carrier 12c which is movable vertically through an aperture in a working table 18. More particularly, locked and loaded holders are moved consecutively into the carrier 12c which moves intermittently downwardly to allow locked and loaded holders to be conveyed into the carrier 12c at the same level on or above the working table 18. Such locked and loaded holders are then conveyed to a carrier 12d for output.

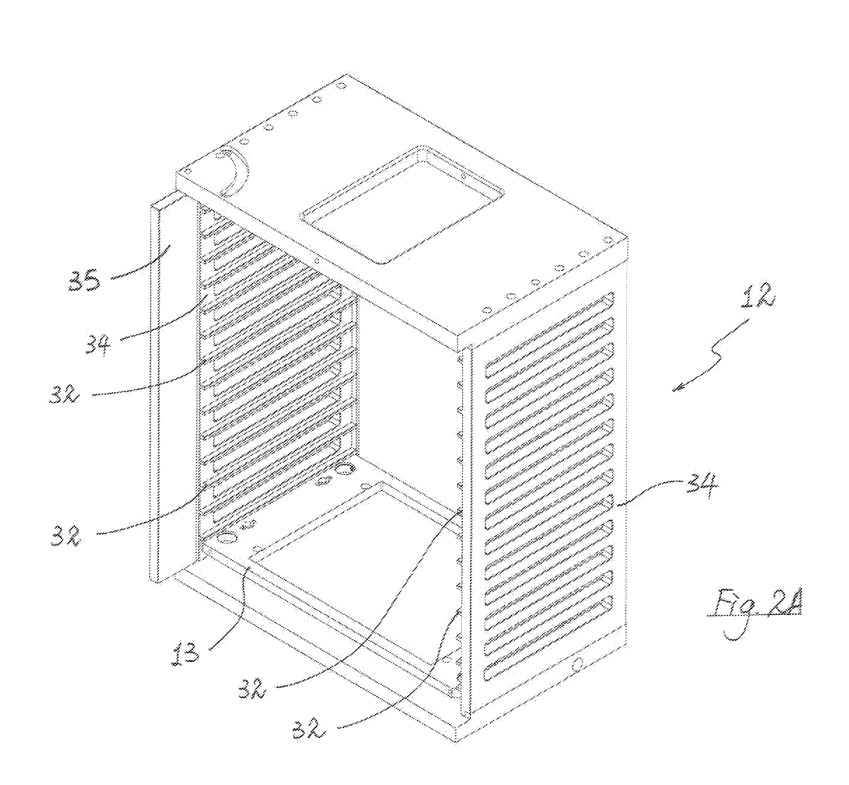

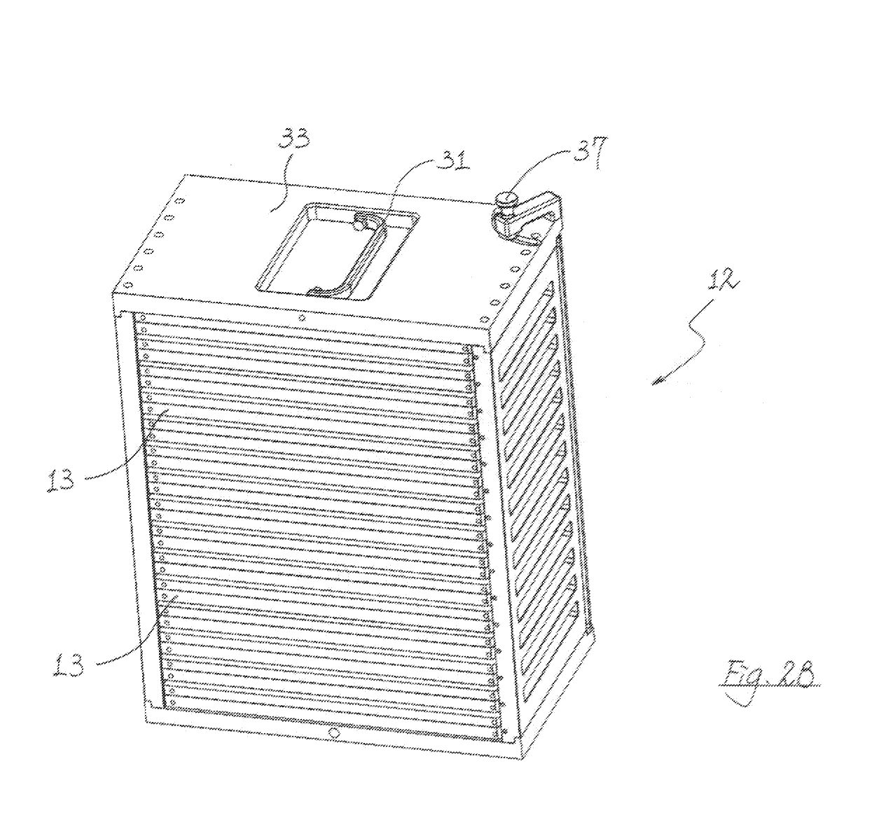

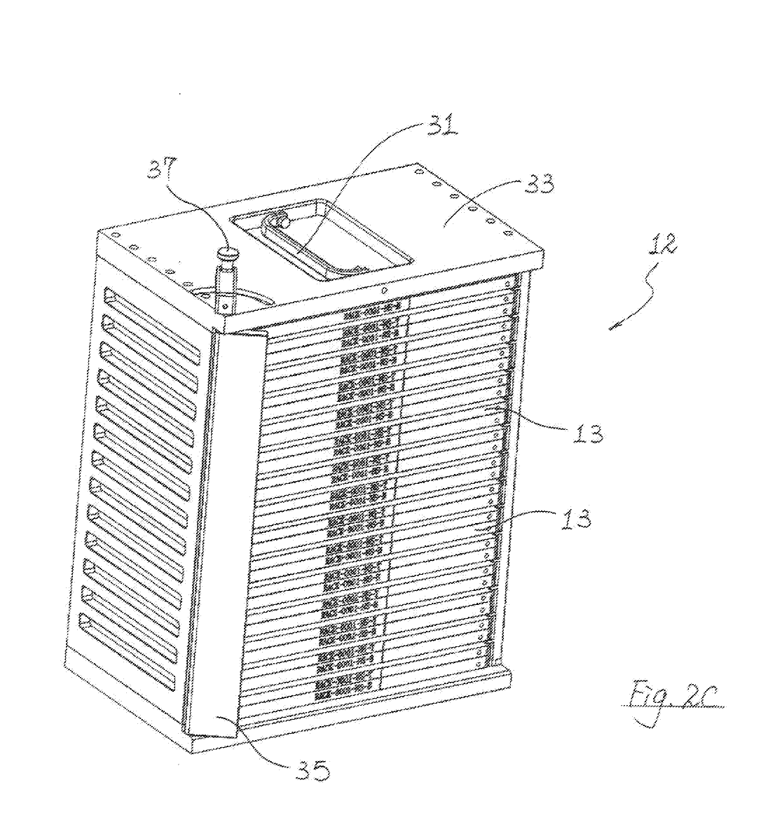

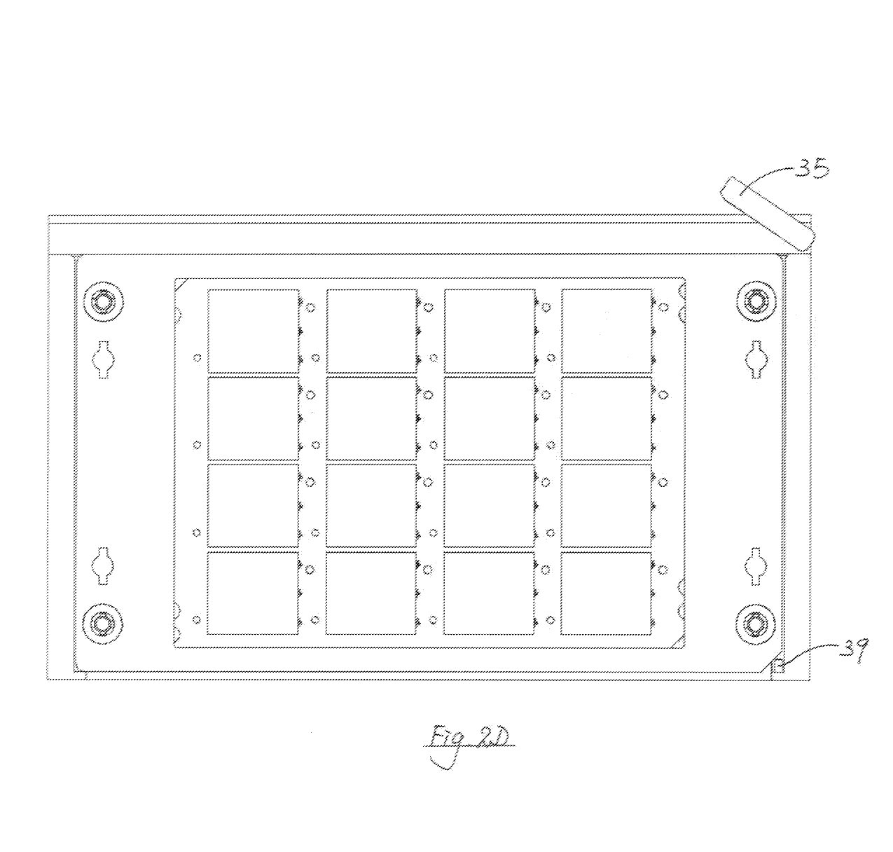

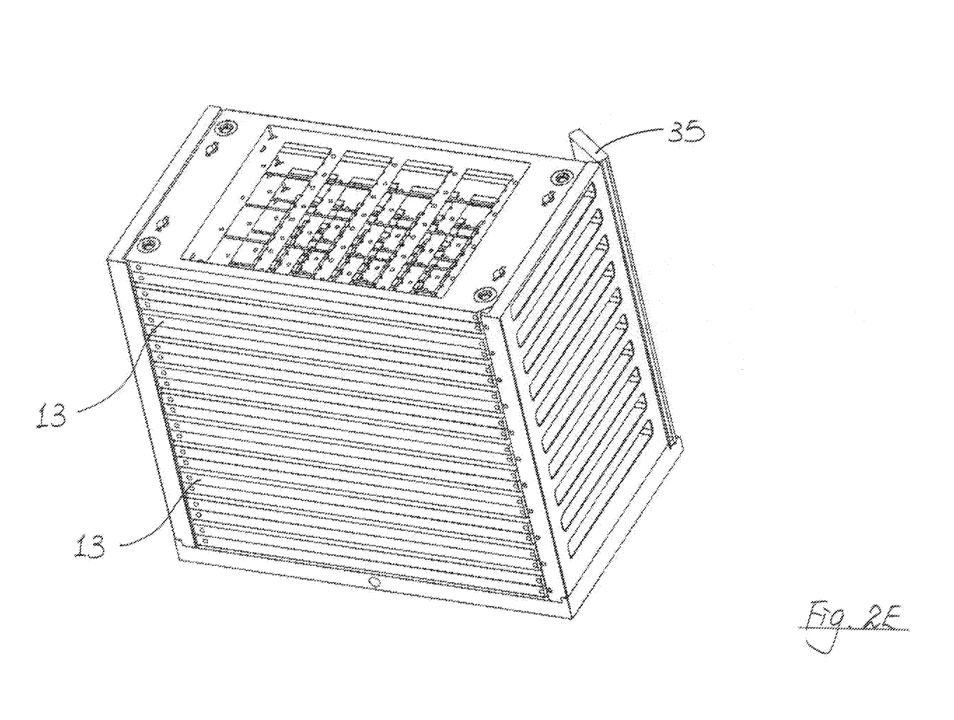

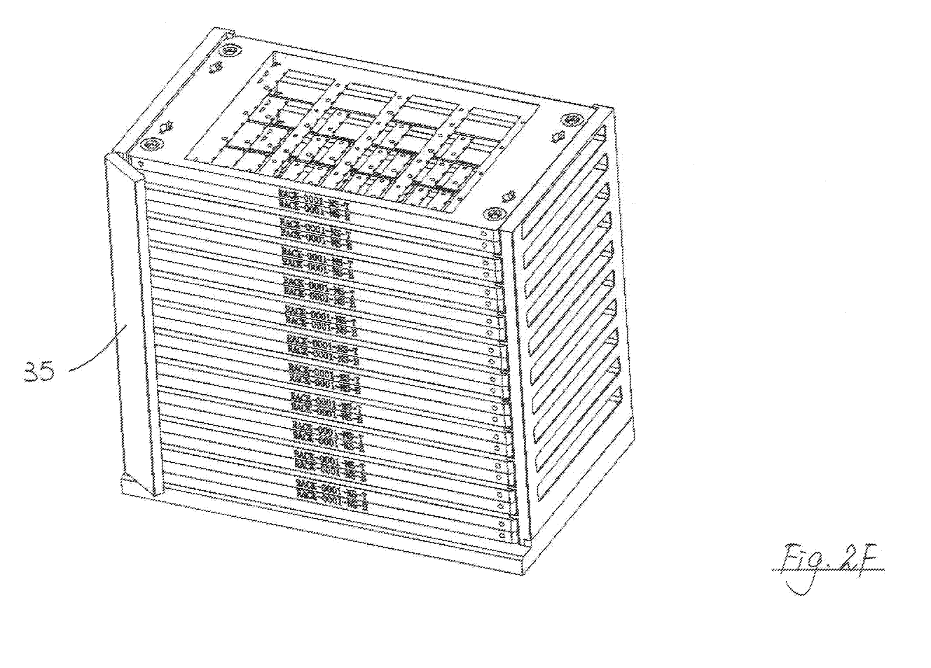

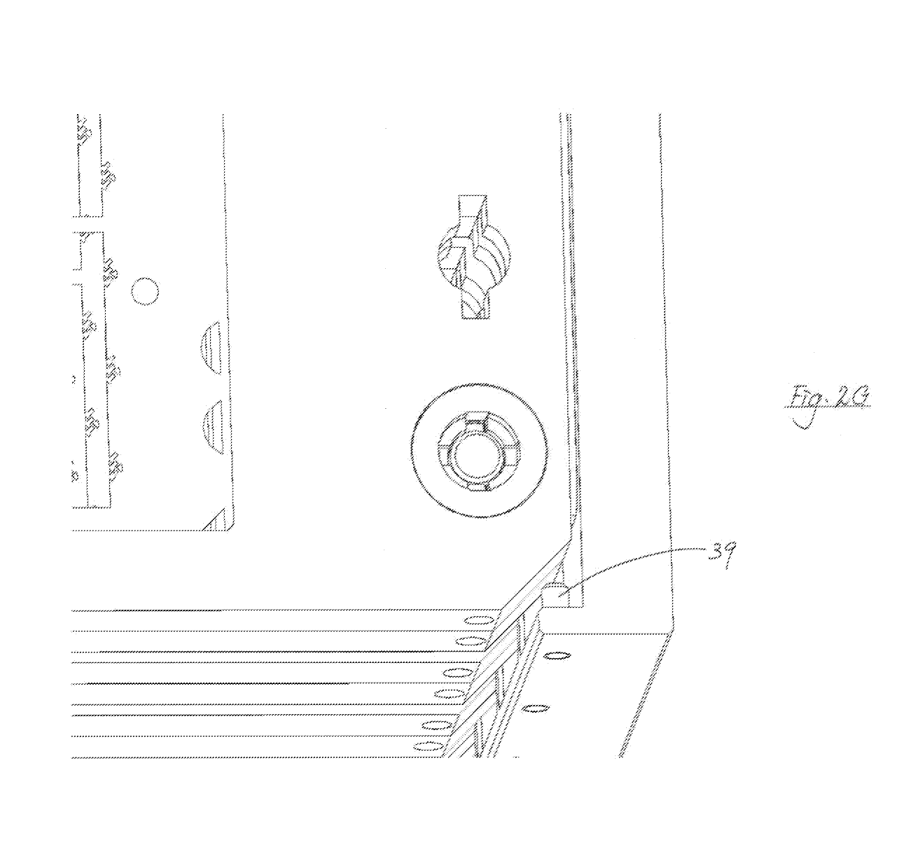

FIG. 2A shows a carrier (generally designated as 12), which can act as the carriers 12a, 12b, 12c, 12d discussed above and shown in FIGS. 1A to 1F. It can be seen that a number of ribs 32 extend from two inner opposite walls 34 of the carrier 12 towards each other for supporting and holding holders 13.

FIGS. 2B and 2C show the carrier 12 as fully stacked with holders 13 one above another. A handle 31 is provided on a top 33 of the carrier 12. The handle 31 is shown in FIGS. 2B and 2C in a lowered position. The handle 31 may be pivoted to a raised position, in which the handle 31 extends generally upwardly away from the top 33 of the carrier 12, to allow the carrier 12 (together with any holder 13 carried in and by it) to be transported either manually or by a machine.

On a front side of the carrier 12 is provided a strip of side door 35 which may be caused to pivot by movement of a knob 37. More particularly, the knob 37 may be moved to pivot the side door 35 between a closed position in which the side door 35 closes part of the front side of the carrier 12 and an open position in which the side door 35 is pivoted away from the closed position by at least around 90°. When the side door 35 is in the closed position, the holders 13 in the carrier 12 cannot be retrieved from the carrier 12; whereas when the side door 35 is in the open position, the holders 13 in the carrier 12 can be retrieved from the carrier 12.

It can be seen in FIGS. 2D to 2G that one corner of each holder 13 is chamfered. Such an arrangement assists in ensuring proper positioning of the holders 13 in the carrier 12. In particular, along one rear corner edge of the carrier 12 is a vertical row (in the sense of FIG. 2F) of protrusions 39 which extend into the interior of the carrier 12. By way of such an arrangement, the holders 13 can only be properly and fully received within the carrier 12 if the respective chamfered corner is immediately adjacent the respective protrusion 39.

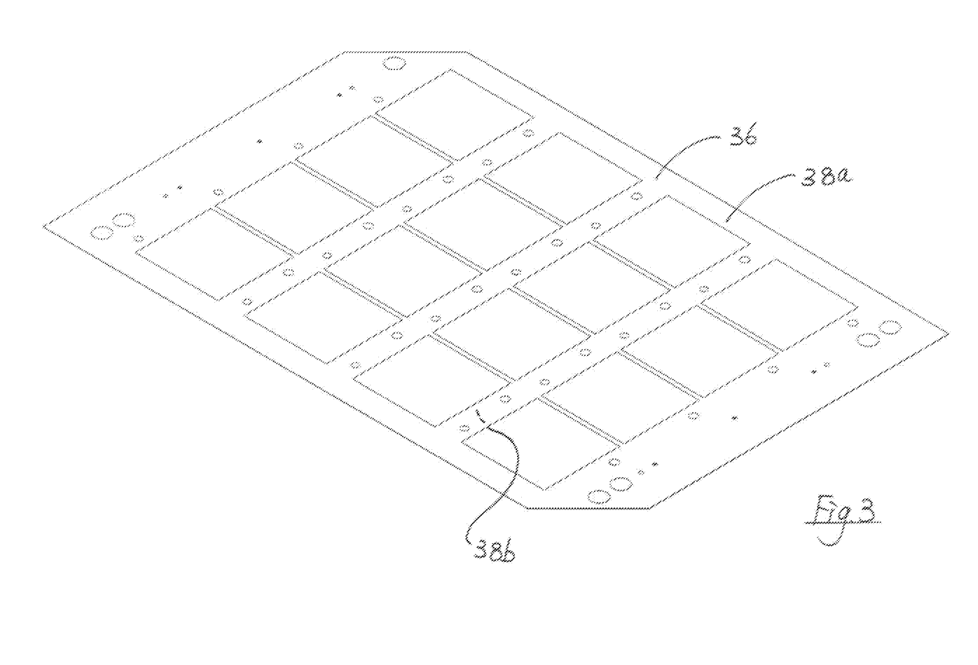

A top perspective view of a sheet of metal 36 (being a workpiece to be held by the holder 13), with an upper major surface 38a and an opposite lower major surface 38b, is shown in FIG. 3.

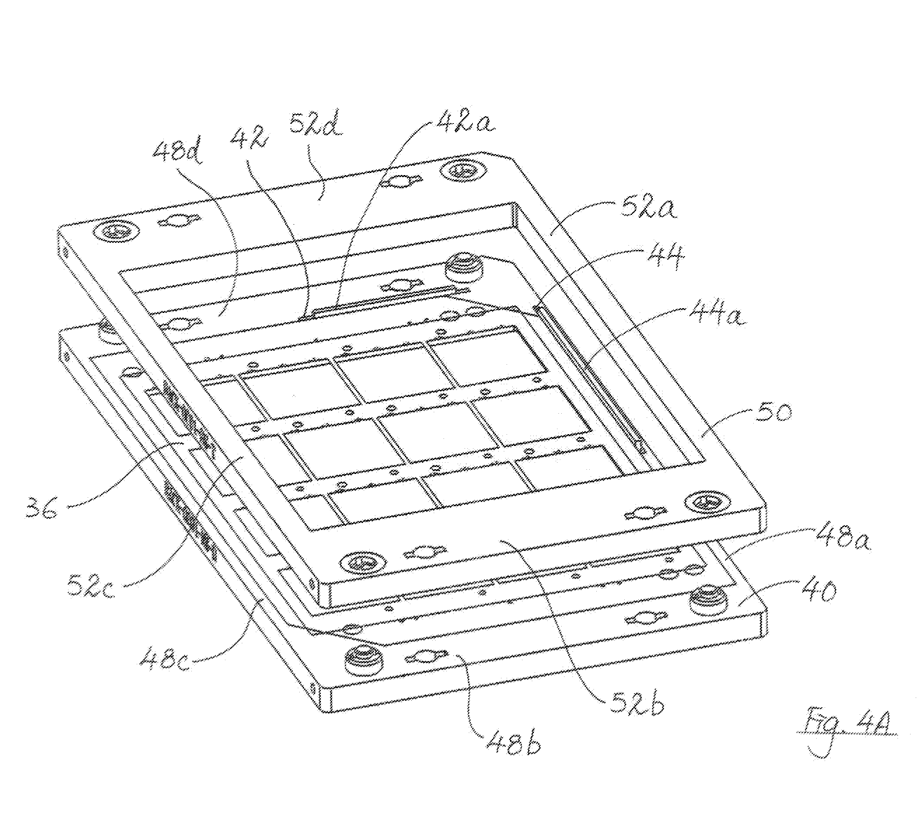

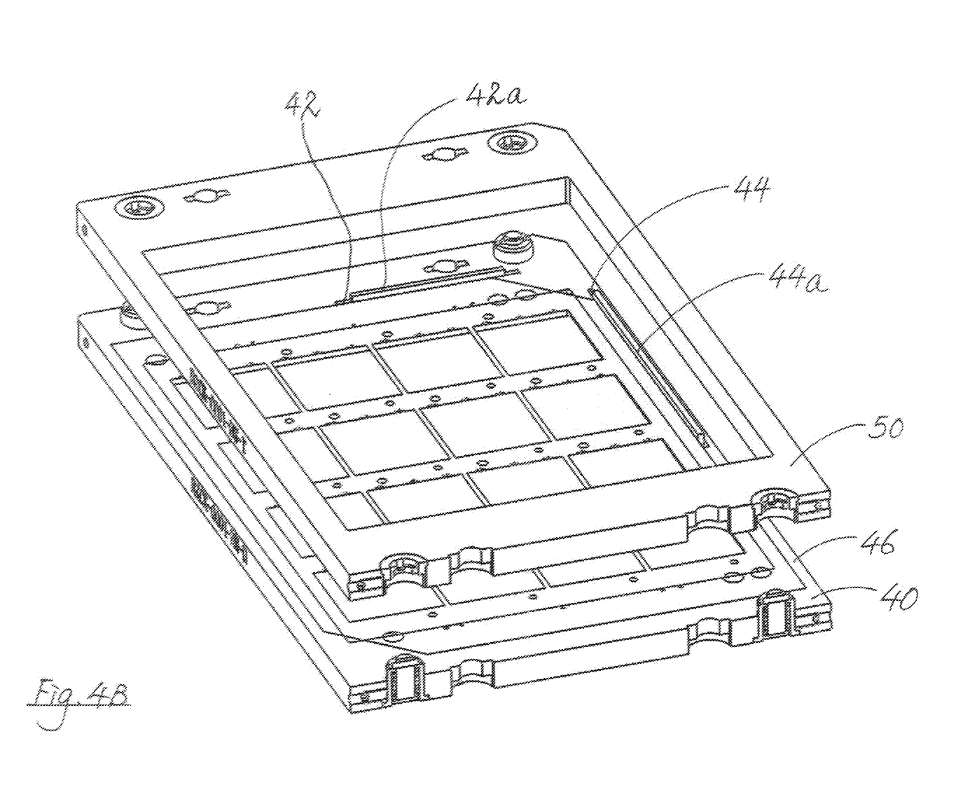

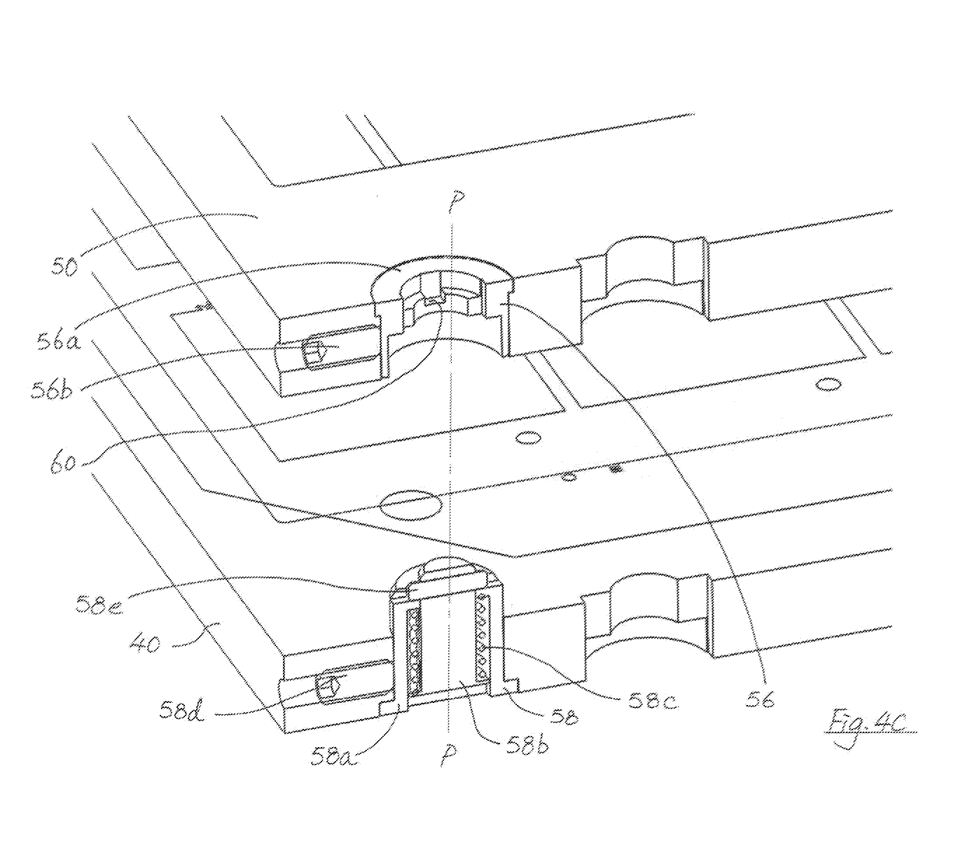

As shown in FIGS. 4A to 4C, the holder 13 is made up of a base 40 and a cover 50 which are engageable with each other. As shown in FIGS. 4A and 4B, the base 40 is provided with two perpendicular slots 42, 44 to each of which a strip of plastic material 42a, 44a is frictionally engaged. Each of the strips of plastic material 42a, 44a extends above an upper surface 46 of the base 40.

One a lower surface of the cover 50 are also provided with two perpendicular slots for receiving the portions of the two strips of plastic material 42a, 44a which extend above the upper surface 46 of the base 40. Such an arrangement allows for easy and precise alignment of the cover 50 and the base 40.

The base 40 has four rims 48a, 48b, 48c, 48d joined with one another in a generally rectangular shape, and thus with four corners. When the sheet of metal 36 is placed on the base 40, part of the lower major surface 38b of the sheet of metal 36 contacts the rims 48a, 48b, 48c, 48d.

As to the cover 50, it also has four rims 52a, 52b, 52c, 52d joined with one another in a generally rectangular shape, and again with four corners. When the sheet of metal 36 is properly placed and positioned on the base 40, the cover 50 may be placed on the sheet of metal 36, such that part of the upper major surface 38a of the sheet of metal 36 contacts the rims 52a, 52b, 52c, 52d of the cover 50. It can be seen that when the sheet of metal 36 is thus held by the holder 13 and between the cover 50 and the base 40, a major proportion of the upper major surface 38a of the sheet of metal 36 is exposed to the outside environment, for subsequent working.

Adjacent each of the four corners of the carrier 13 is a locking mechanism 54 which extends through the base 40 and the cover 50.

As shown more clearly in FIG. 4C, each locking mechanism 54 includes an upper part 56 carried by the cover 50 and a lower part 58 carried by the base 40. The upper part 56 includes a generally cylindrical hollow part 56a and a side screw 56b. When the side screw 56b is inserted into the cover 50 in the position as shown in FIG. 4C in which it abuts the cylindrical hollow part 56a, it prevents (a) rotation of the hollow cylindrical part 56a relative to the cover 50 about the longitudinal axis P-P common to both the upper part 56 and the lower part 58 of the locking mechanism 54 and (b) linear movement of the hollow cylindrical part 56a relative to the cover 50 along the axis P-P. It is also clearly shown in FIG. 4C that a trough 60 is provided along a peripheral edge of the cylindrical hollow part 56a of the upper part 56. It should be noted that FIG. 4C is a sectional view, and that there is a corresponding trough (not shown) at a diametrically opposed position along the peripheral edge of the cylindrical hollow part 56a of the upper part 56.

As to the lower part 58, such includes an outer generally cylindrical hollow part 58a, a inner spindle 58b, a spring 58c, a side screw 58d and a pin 58e. When the side screw 58d is inserted into the base 40 in the position as shown in FIG. 4C in which it abuts the outer cylindrical hollow part 58a, it prevents (a) rotation of the outer part 58a relative to the base 40 about the axis P-P and (b) linear movement of the outer part 58a relative to the base 40 along the axis P-P.

The inner spindle 58b is movable relative to the outer hollow part 58a along the axis P-P between a lowered position (as shown in FIG. 4C) in which it rests on the outer hollow part 58a of the lower part 58 and a raised position in which it is inserted further into the interior of the outer hollow part 56a of the upper part 56. The inner spindle 58b is biased to the lowered position by the spring 58c. When the inner spindle 58b is in its lowered position, the locking mechanism 54 is in an unlocked configuration. When all the locking mechanisms 54 of a carrier 13 are in an unlocked configuration, the cover 50 and the base 40 of the carrier 13 are also unlocked and can be detached from each other.

The inner spindle 58b is also rotatable relative to the outer hollow part 56a of the upper part 56 and the outer hollow part 58a of the lower part 58 about the axis P-P. It can be seen that the pin 58e, which is carried by the inner spindle 58b for simultaneous movement, is elongate and extends in a direction perpendicular to the axis P-P. Rotation of the inner spindle 58b relative to the outer hollow part 58a will cause corresponding rotation of the pin 58e relative to the outer hollow part 58a.

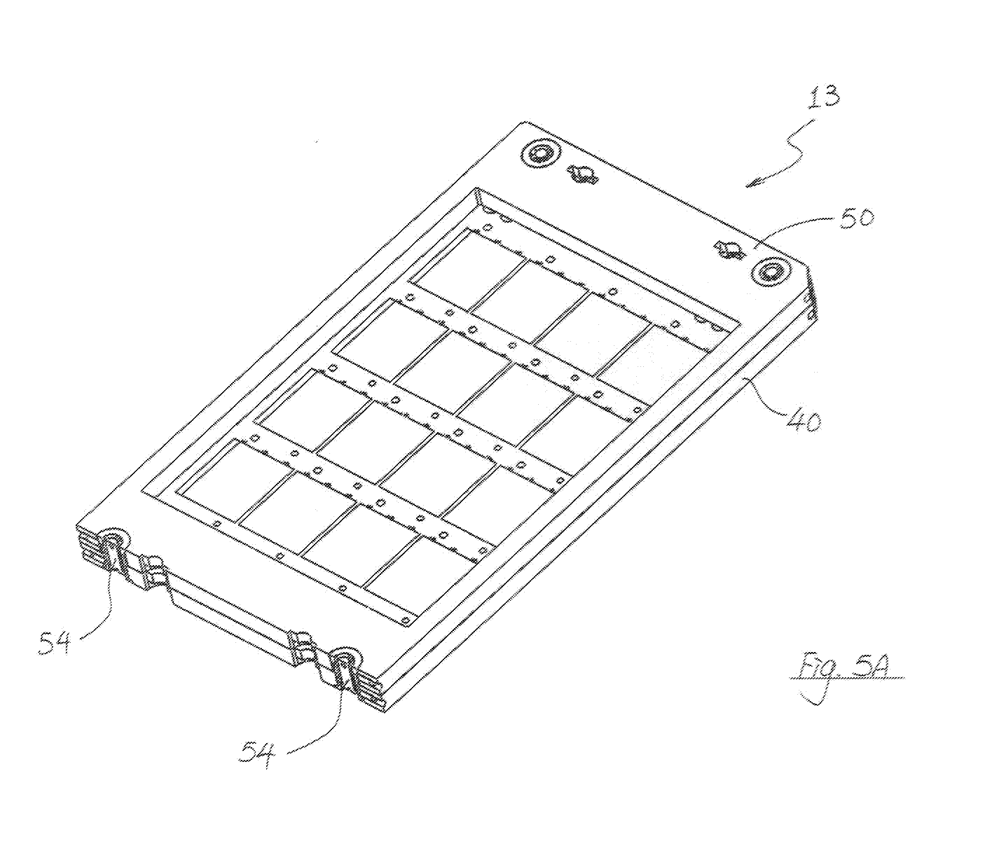

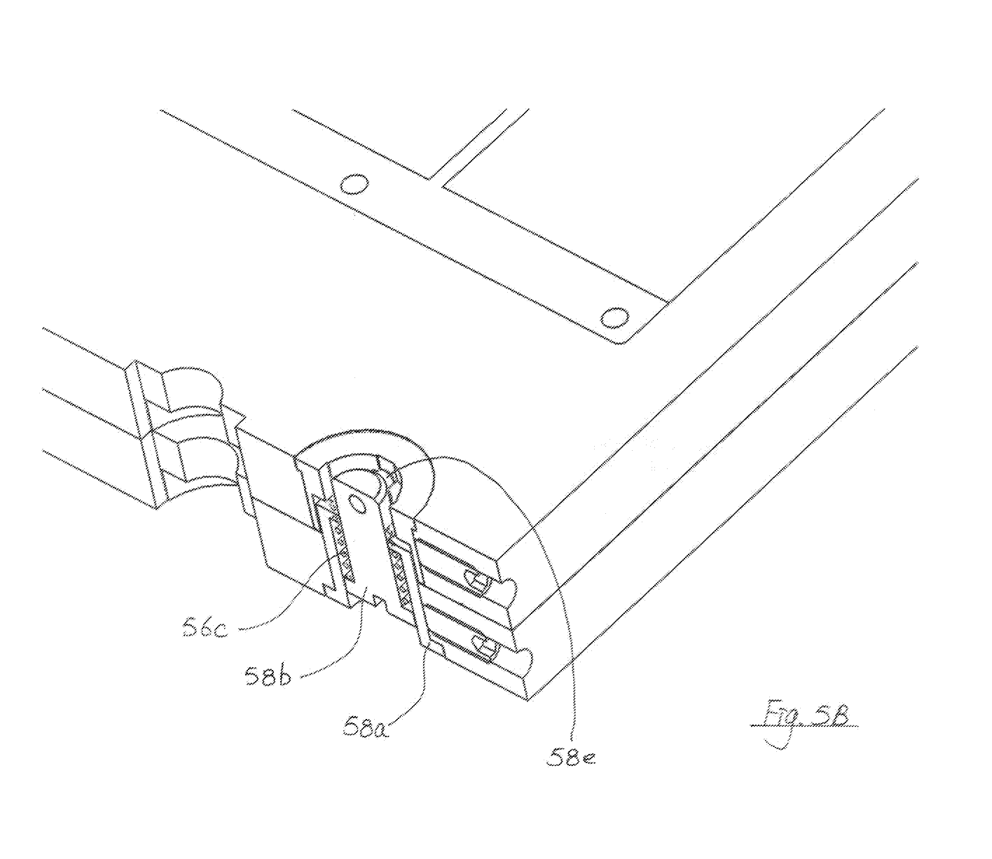

FIGS. 5A and 5B show the locking mechanisms 54 of the carrier 13 in a locked configuration, in which the cover 50 and the base 40 are properly aligned, engaged and fixedly secured with each other. Referring in particular to FIG. 5B, the inner spindle 58b is moved (against the biasing force of the spring 56c) to its raised position and rotated relative to the outer hollow part 58a by 90° (in either direction) so as to bring the pin 58e within the troughs 60. In this position, detachment of the cover 50 and the base 40 is prevented, and thus they are locked against relative movement.

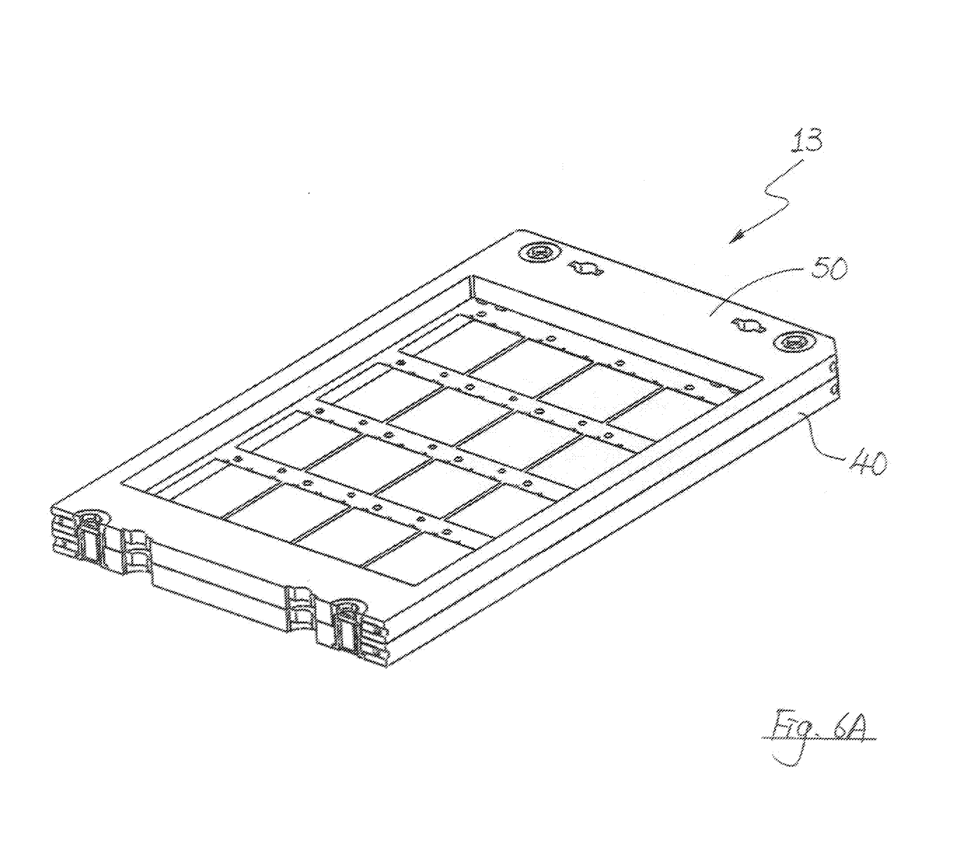

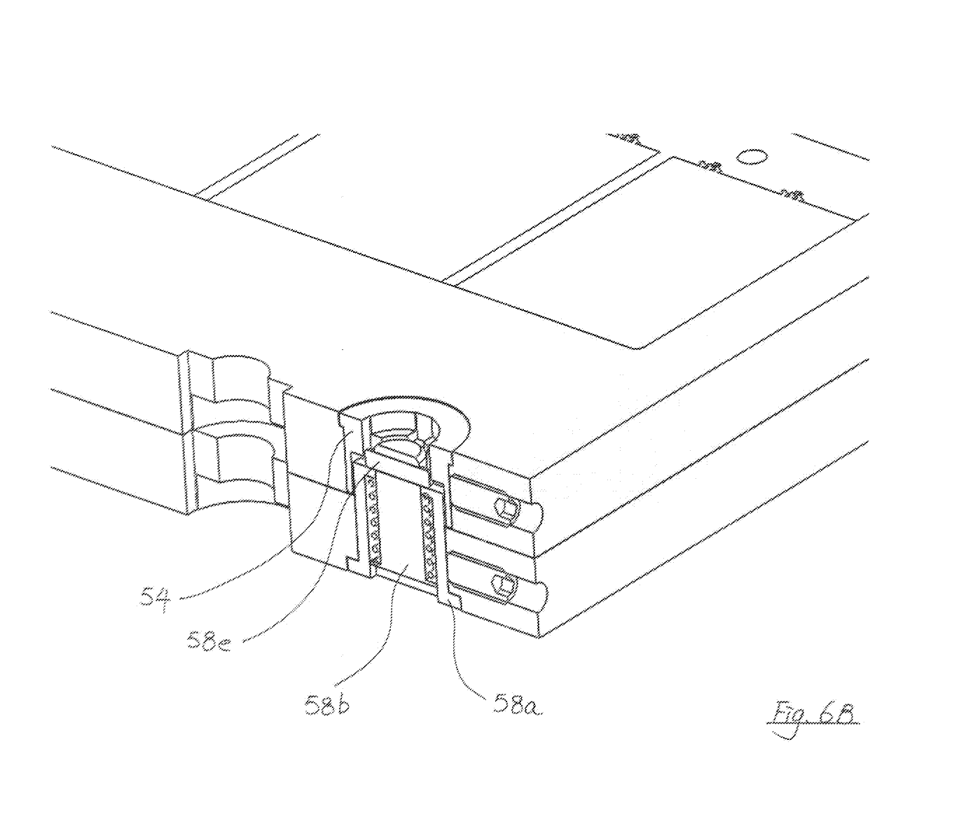

To unlock the carrier 13, the inner spindle 58b is first pushed further into the outer hollow part 56a of the upper part 56, and is then rotated by 90° (in either direction) relative to the outer hollow part 58a, to turn the pin 58e by the same angle, whereby the pin 58e is removed from the troughs 60 and in a position relative to the outer hollow part 58a in which the inner spindle 58b is then allowed to be moved to the lowered position under the biasing force of the spring 56c. In particular, the inner spindle 58b is shown in the lowered position in FIGS. 6A and 6B, in which the locking mechanism 54 is in its unlocked configuration. When all the locking mechanisms are in the unlocked configuration, the cover 50 and the base 40 are detachable from each other.

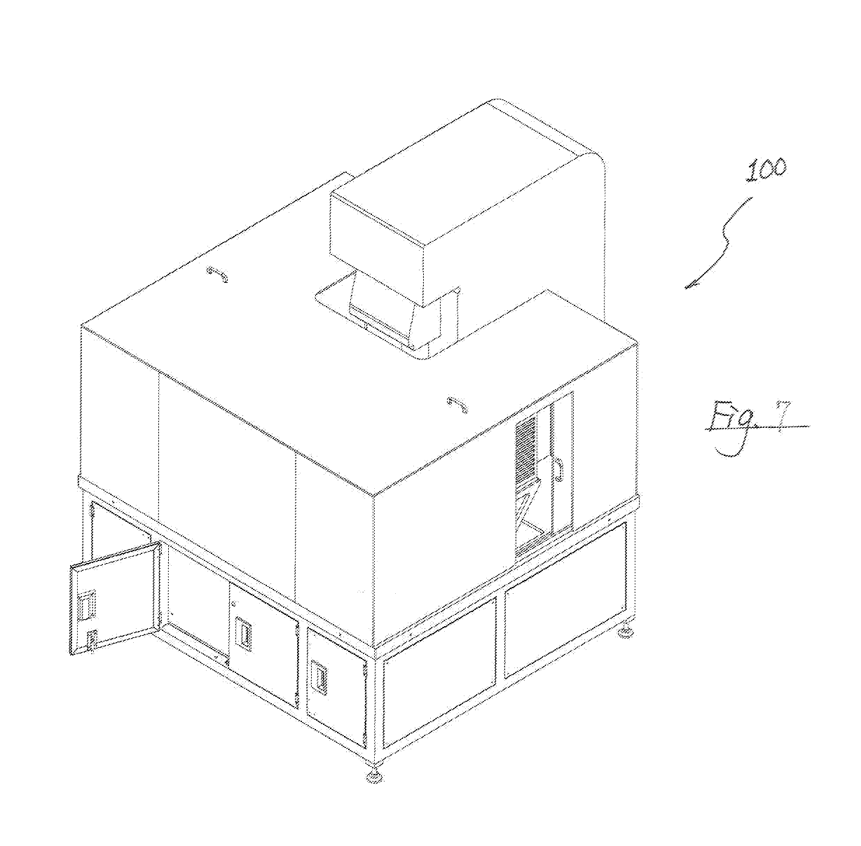

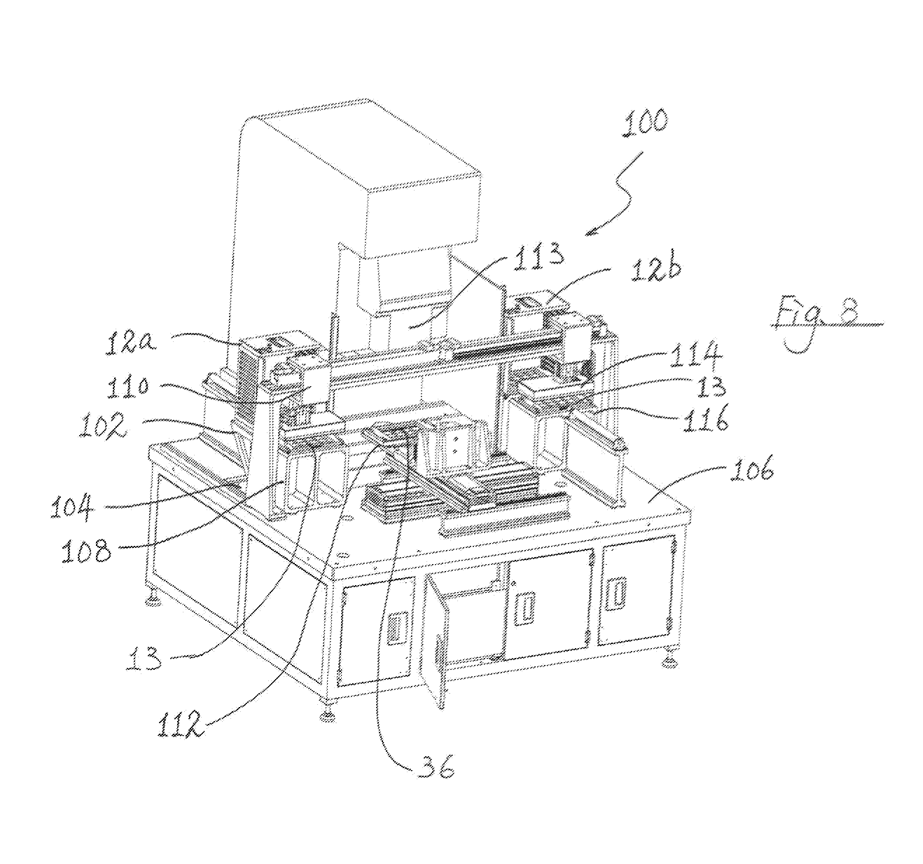

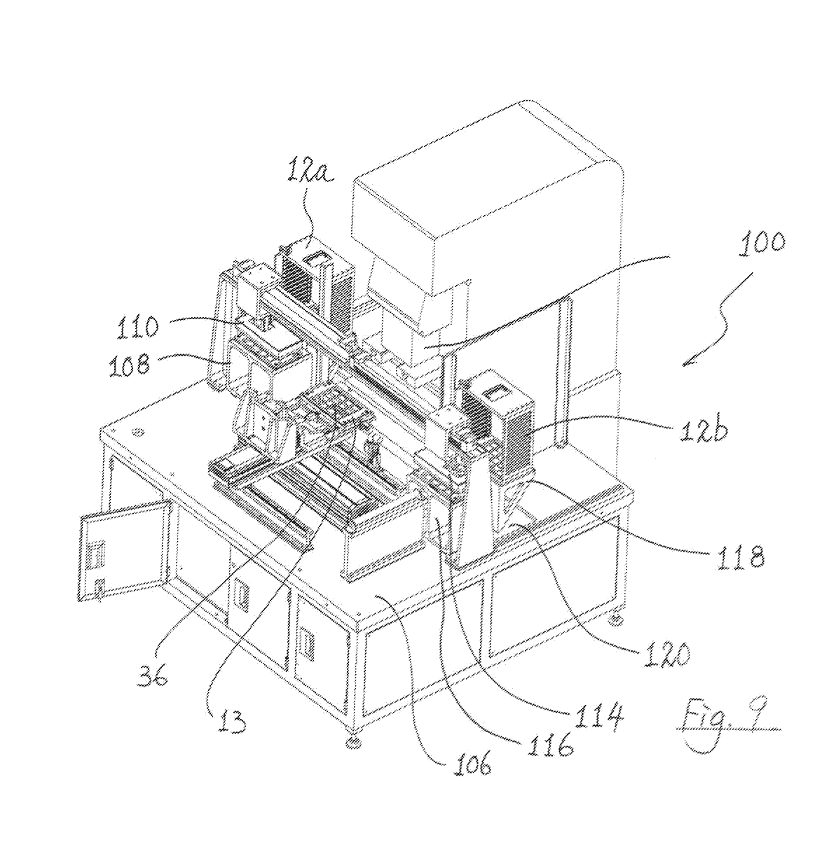

FIG. 7 shows a top perspective view of a metal forming machine, in particular a stamping machine, according to the present invention, generally designated as 100. As shown in more detail in FIGS. 8 and 9, a carrier 12a containing a number of locked and loaded holders 13 (as discussed above) is placed on a movement platform 102 which may be raised and lowered through a hole 104 of a working table 106 of the machine 100. When a topmost holder 13 in the carrier 12a is raised to a pre-determined level above the working table 106, the holder 13 is moved to a first working platform 108. A first robot arm 110 then moves to pick up (e.g. by a number of claws) the locked and loaded holder 13 and places the holder 13 on a second working platform 112, which may move the holder 13 in the x- and y-directions, so as to position the holder 13 for subsequent stamping procedure. When the holder 13 is accurately positioned, a stamping head 113 of the machine 100 is driven down to stamp a sheet of metal 36 securely loaded into and held by the holder 13.

After the stamping action, a second robot arm 114 picks up (e.g. by a number of claws) the holder 13 with the stamped sheet of metal 36 from the second working platform 112 and places it on a third working platform 116. The holder 13 is then moved from the third working platform 116 into a carrier 12b resting on a movement platform 116. The movement platform 116 is movable up and down through a hole 120 through the working table 106, for subsequent output of the carrier 12b carrying locked holders 13 each holding a stamped sheet of metal 36.

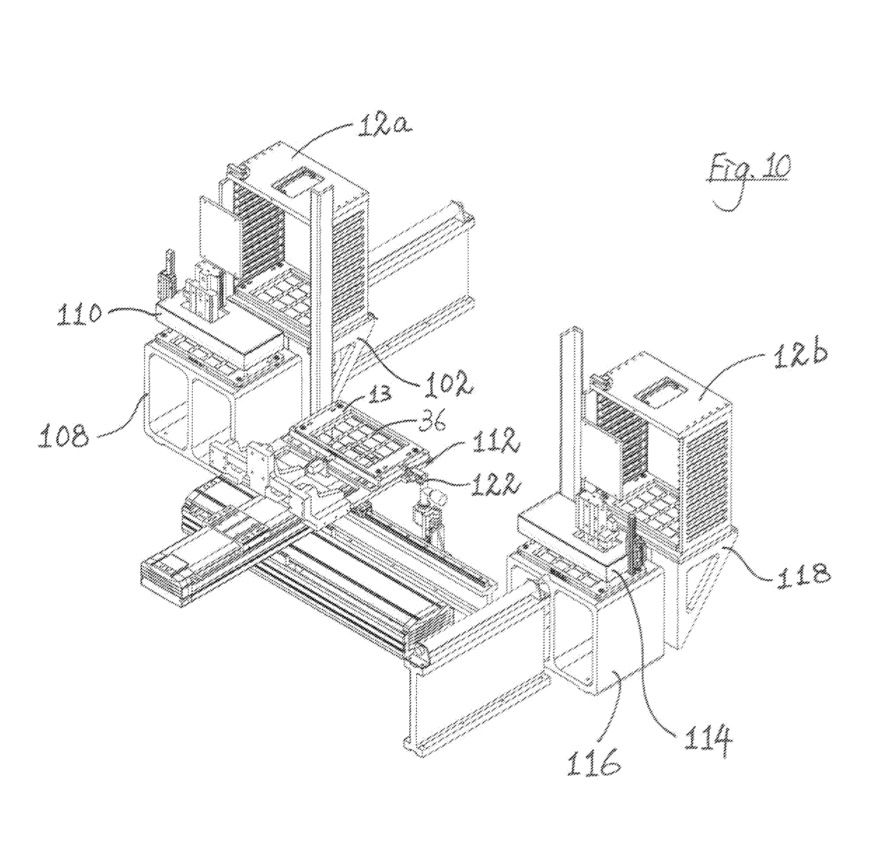

FIG. 10 shows in more detail the mechanism for moving the locked and loaded holders 13 through the first, second and third working platforms 108, 112, 116. As mentioned above, when a topmost holder 13 in the carrier 12a is raised to a pre-determined level above the working table 106, the holder 13 is moved to the first working platform 108. After movement of this holder 13 to the first working platform 108, the movement platform 102 is raised by a pre-determined height to raise a next holder 13 in the carrier 12 to the pre-determined level above the working table 106, ready to be moved to the first working platform 108.

A monitoring camera 122 is positioned next to where the holder 13 should be positioned for the stamping step, to determine whether the second working platform 112, the holder 13 and the sheet of metal 36 held by the holder 13 are properly positioned before each stamping action. If not, the second working platform 112 is moved in either or both the x-direction and y-direction to correctly position the holder 13 and the sheet of metal 36 held by it.

After stamping, the holder 13 with the stamped sheet of metal 36 is moved by the second robot arm 114 to the third working platform 116, to be subsequently moved into the carrier 12b. Once a holder 13 is moved into the carrier 12b, the carrier 12b is lowered through the hole 120 of the working table 106 by a pre-determined height to allow space for reception of a subsequent holder 13.

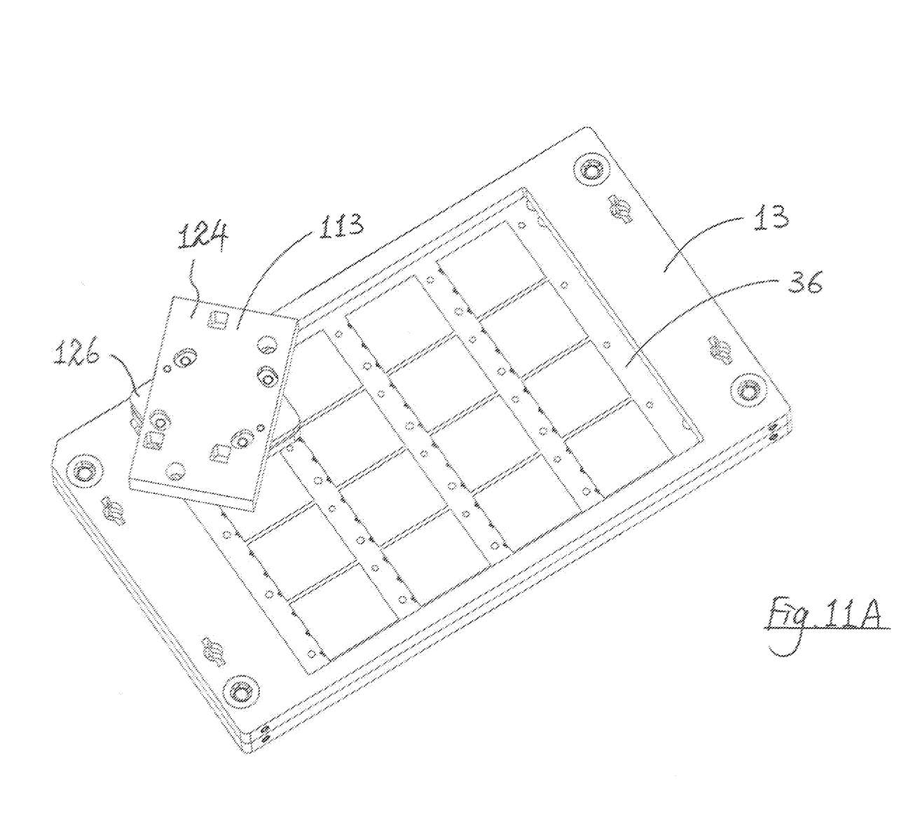

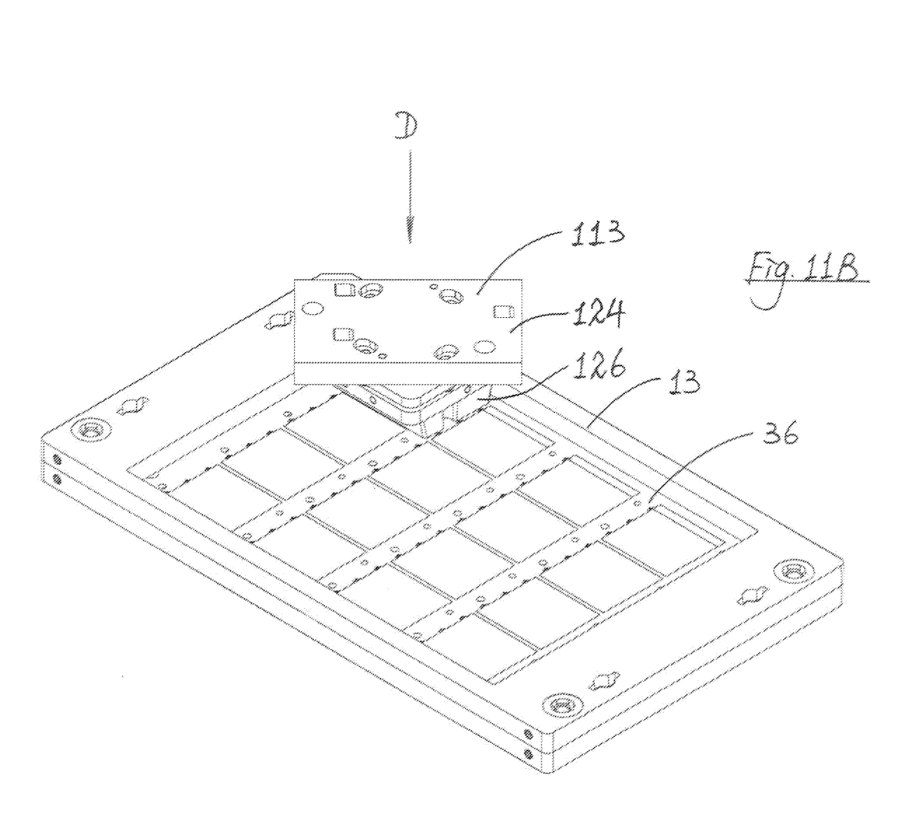

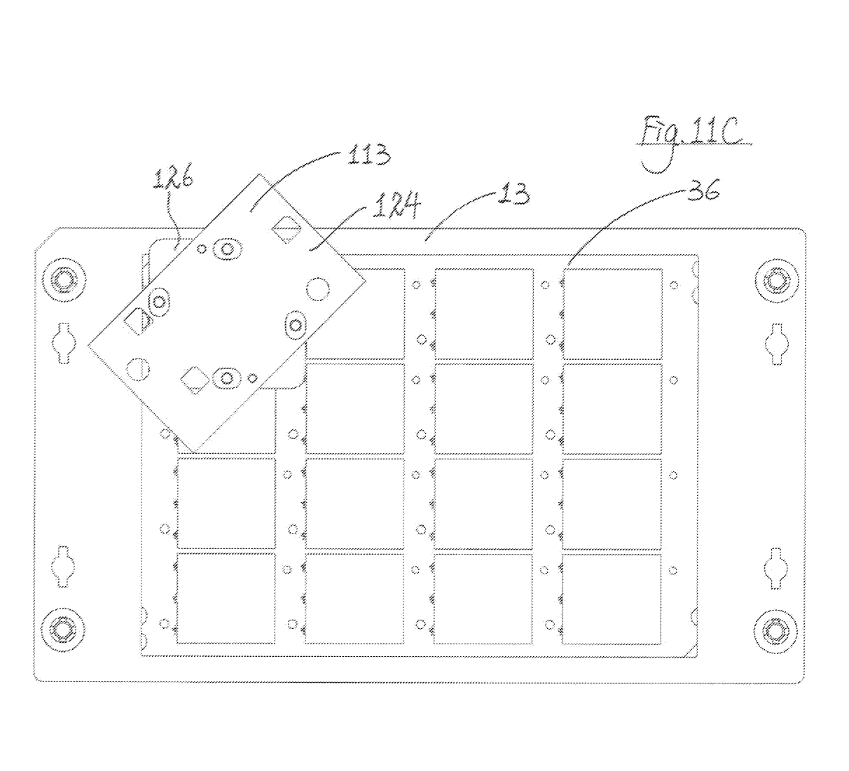

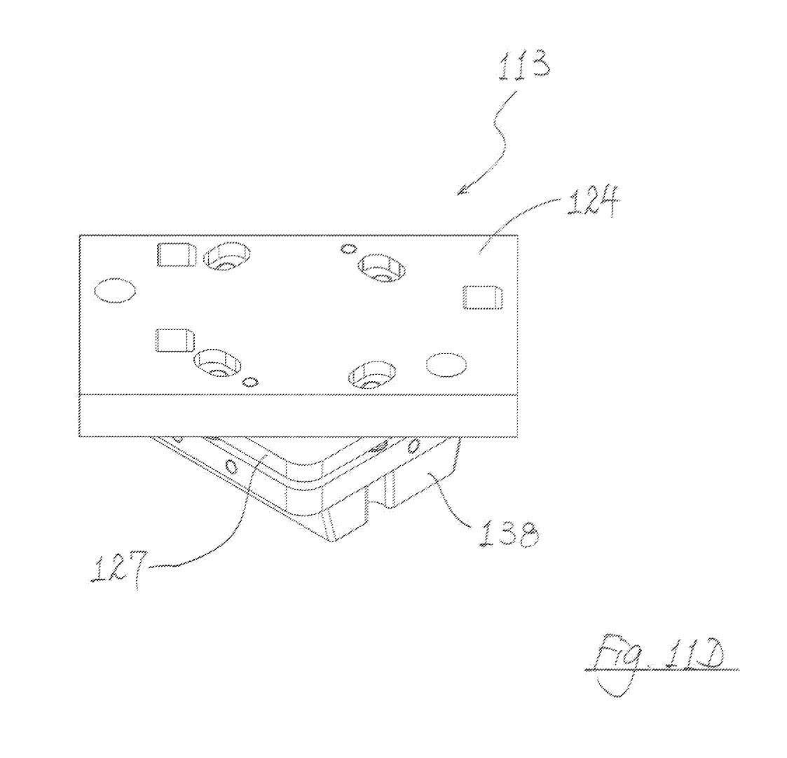

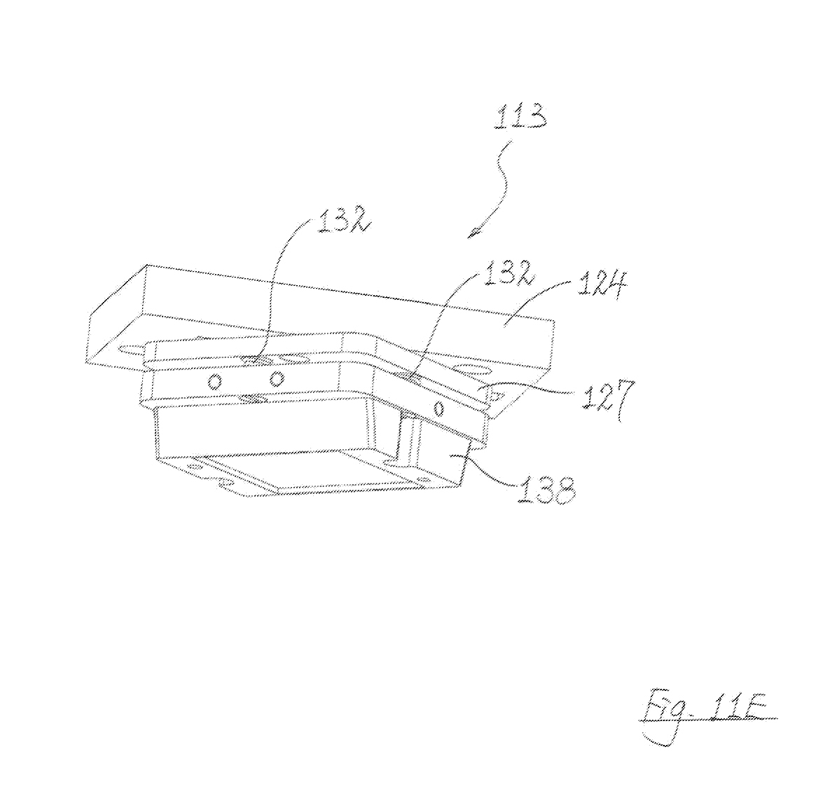

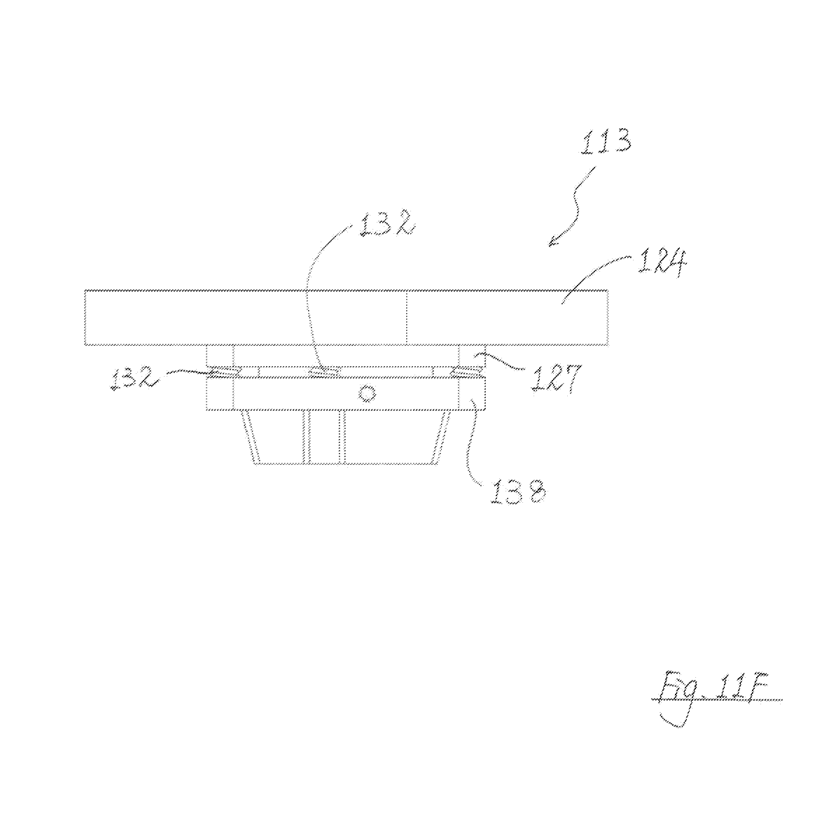

FIGS. 11A to 11C show various views of the stamping head 113 of the stamping machine 100 acting on the sheet of metal 36 held by the holder 13. The stamping head 113 has a stamping die 124 and a die holder 126. As shown more clearly in FIGS. 11D to 11F, the die holder 126 has an intermediate part 127 and an abutment part 138. The stamping die 124, the intermediate part 127 of the die holder 126 and the abutment part 138 of the die holder 126 are engaged with one another by a number of bolts 132. When properly installed, the stamping die 124 is in constant contact for simultaneous movement with the intermediate part 127; the stamping die 124 and the intermediate part 127 of the die holder 126 are movable relative to the abutment part 138 of the die holder 126.

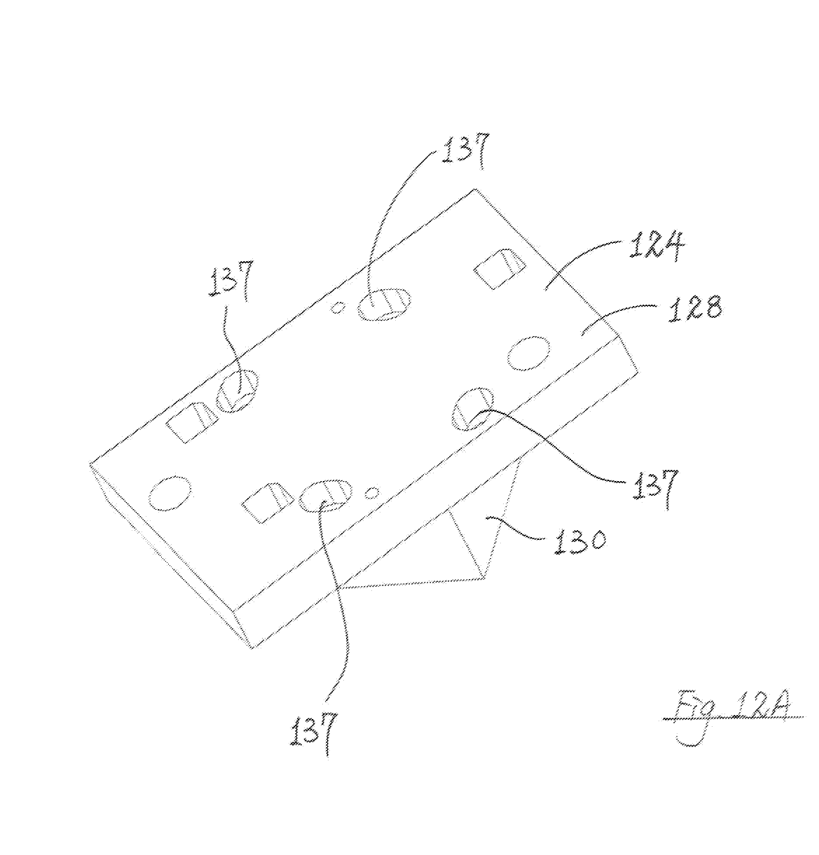

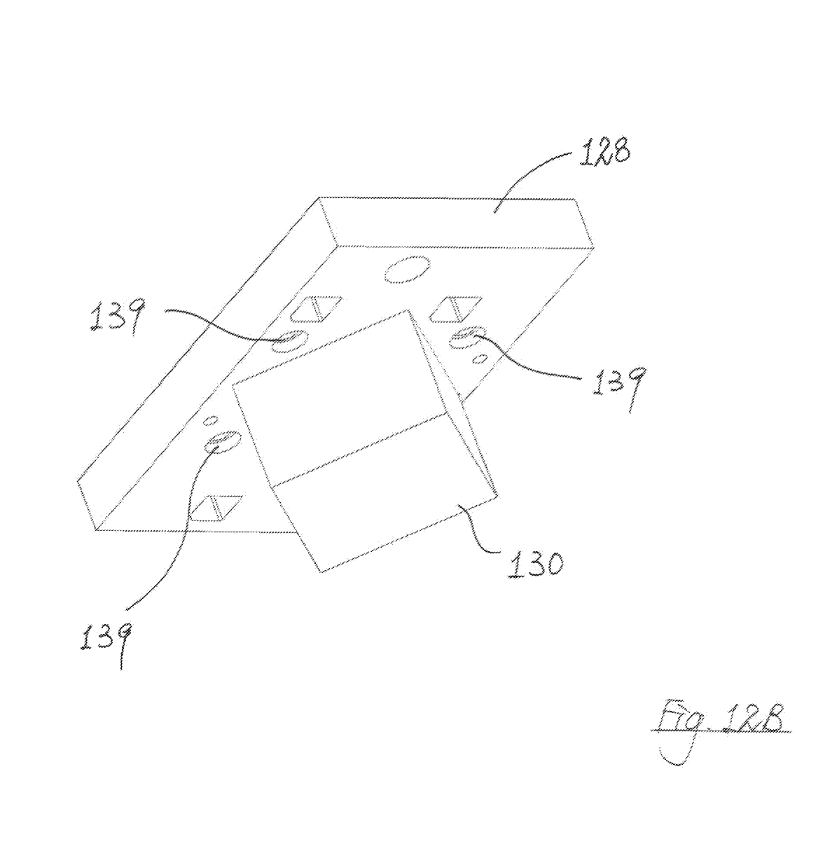

FIGS. 12A and 12B show, respectively, a top perspective view and a bottom perspective view of the stamping die 124. The stamping die 124 has a head 128 to be engaged with a driving system of the machine 100, and a stamping portion 130 to stamp on and through the sheet of metal 36. The head 128 and the stamping portion 130 are integrally formed with each other.

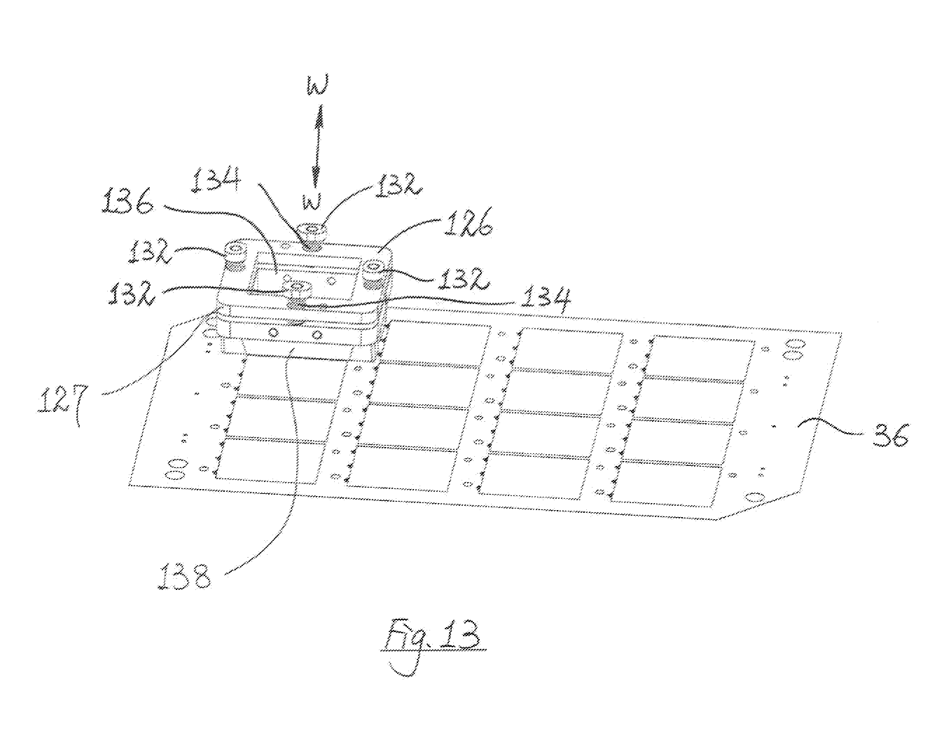

FIG. 13 shows the sheet of metal 36 being acted on by the die holder 126 (with the stamping die 124 of the stamping head 113 removed). Four bolts 132 are received through the die holder 126. The bolts 132 are movable relative to the abutment part 138 of the die holder 126 along their respective longitudinal axis (i.e. upwardly and downwardly in the direction of the bi-directional arrow W-W). Each of the bolts 132 is associated with a spring 134 which biases the respective bolt 132 upwardly, i.e. away from the abutment part 138 of the die holder 126. Each of the bolts 132 has an enlarged head 135 which is received within a respective oblong recess 137 in the head 128 of the stamping die 124. Each oblong recess 137 is joined with a cylindrical hole 139 of a smaller size than the oblong recess 137. As the diameter of the head 135 is larger than the hole 139, when the bolts 132 are moved downwardly towards the abutment part 138 of the die holder 126, the stamping die 124 (and thus the stamping portion 130) and the intermediate part 127 of the die holder 126 will be brought into simultaneous downward movement. Normally, the stamping die 124 and the intermediate part 127 of the die holder 126 are at an upper position in which the intermediate part 127 of the die holder 126 is spaced apart from the abutment part 138 of the die holder 126 by the upward biasing force of the springs 134.

Each of the intermediate part 127 and the abutment part 138 of the die holder 126 has a rectangular through hole, which, when the stamping head 113 is properly installed, collectively form a through hole 136 for receiving there-through the stamping portion 130 of the stamping die 124 for relative movement. In particular, the stamping portion 130 of the stamping die 124 is movable within and relative to the through hole 136 upwardly and downwardly in the direction of the bi-directional arrow W-W, e.g. for stamping the sheet of metal 36. The allowed distance of downward movement of the stamping die 124 relative to the abutment part 138 of the die holder 126 is the distance by which the intermediate part 127 of the stamping die 124 is spaced apart from the abutment part 138 of the die holder 126 when the stamping die 124 is in its upper spring-biased position.

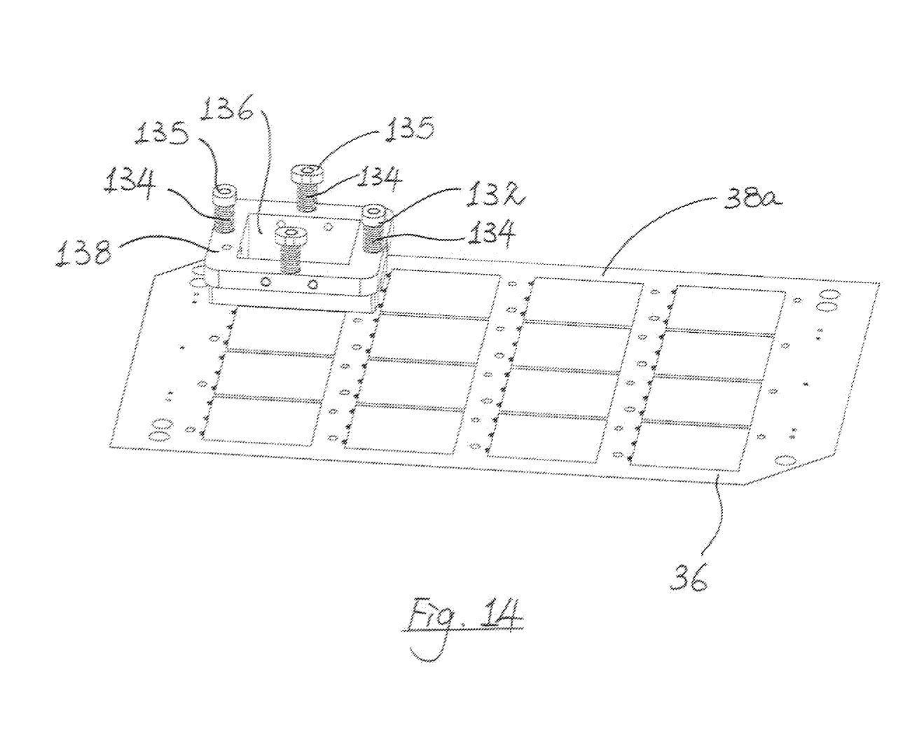

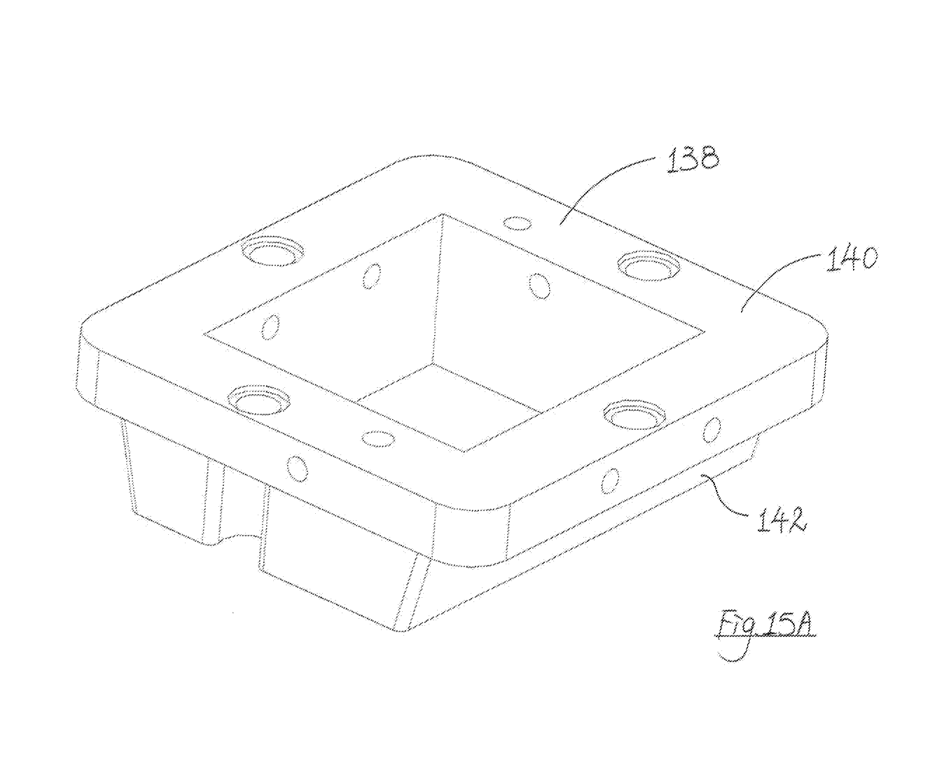

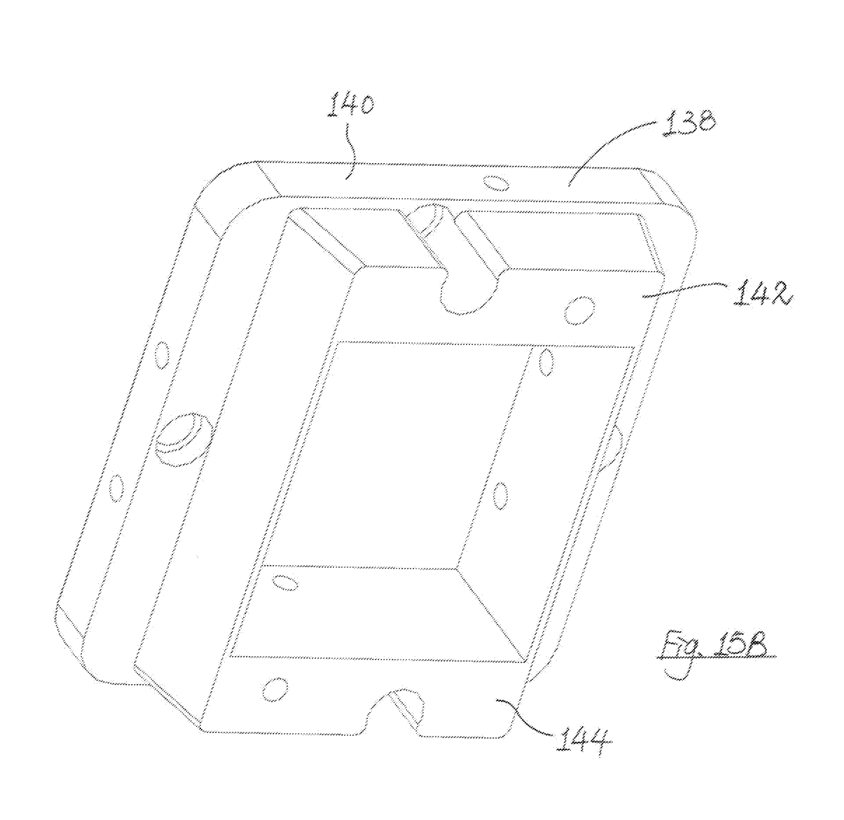

As shown in FIGS. 13 and 14, the abutment part 138 contacts the upper major surface 38a of the sheet of metal 36 during the stamping action. FIGS. 15A and 15B show, respectively, a top perspective view and a bottom perspective view of the abutment part 138 of the die holder 126 of the stamping head 113. It can be seen that the abutment part 138 has a generally rectangular head 140 and a downwardly tapering bottom 142 with a generally rectangular rim-shaped bottom surface 144.

For stamping the sheet of metal 36 held in the holder 13, the holder 13 is positioned such that a first area (called “working area”) of the sheet of metal 36 to be worked on is below the stamping head 113. The stamping head 113 is then moved downwardly towards the sheet of metal 36 until the bottom surface 144 (which faces away from the die 124) of the bottom 142 of the abutment part 138 of the die holder 126 just abuts and exerts a slight stabilizing force on the sheet of metal 36, downwardly in a direction indicated by the arrow D in FIG. 11B, which is perpendicular to the upper major surface 38a of the sheet of metal 36. More particularly, this stabilizing force is applied by the bottom surface 144 along the periphery of the working area, which is rectangular in shape.

While maintaining the abutment between the abutment part 138 and the sheet of metal 36 and thus the stabilizing force on the sheet of metal 36, the stamping die 124 is moved from its upper spring-biased position (in which the forming portion 130 of the die 124 does not extend through a plane containing the bottom surface 144 of the abutment part 138) simultaneously with the bolts 132 and the intermediate part 127 of the die holder 126, downwardly relative to the abutment part 138 of the die holder 126 and against the upwardly biasing force of the springs 134, to move the stamping portion 130 downwardly to a lower position relative to the die holder 126 (in which the intermediate part 127 comes into contact with the abutment part 138 of the die holder 126 and the forming portion 130 extends through the plane containing the bottom surface 144 of the abutment part 138) to stamp the sheet of metal 36, to thereby exert a second downward force (in the same direction as indicated by the arrow D in FIG. 11B) on the first working area of the sheet of metal 36 for forming the sheet of metal 36.

The second downward force for forming the sheet of metal 36 is applied while the stabilizing force is still being applied on the sheet of metal 36. In addition, the second downward force for forming the sheet of metal 36 is larger than the stabilizing force.

After stamping, the stamping die 124 is returned to its upper position by the upward biasing force of the springs 134. The holder 13 is then moved so that a second working area of the sheet of metal 36 is below the stamping head 113 for subsequent stamping, until all the necessary working areas of the sheet of metal 36 are stamped.

It is found in practice that, with the application of a stabilizing force on the sheet of metal 36 during stamping, the quality of stamping is enhanced, with less undesirable tearing effect.

It can also be seen that by way of the present invention, the efficiency of the stamping process is improved and precise positioning of sheets of metal for stamping can be achieved.

It should be understood that the above only illustrates examples whereby the present invention may be carried out, and that various modifications and/or alterations may be made thereto without departing from the spirit of the invention. In particular, it should be understood that, in this document, the word “metal” is intended to cover “metal alloy” as well.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

What is claimed is:

1. A holder for holding at least one sheet of metal, said holder comprising:
a first holder member adapted to engage with part of a first major surface of the at least one sheet of metal,
a second holder member adapted to engage with part of a second major surface of said at least one sheet of metal, and
a securing device for fixedly securing said first holder member with said second holder member,
wherein said first holder member and said second holder member are engageable with each other to hold said at least one sheet of metal therebetween, and
wherein said securing device includes a first part engaged with said first holder member and a second part engaged with said second holder member.

2. The holder according to claim 1 wherein said first part includes a first hollow part.

3. The holder according to claim 1 wherein said first part includes a side screw.

4. The holder according to claim 1 wherein said second part includes a second hollow part and an inner spindle, and wherein said inner spindle is movable relative to said second hollow part.

5. The holder according to claim 4 wherein, when said first holder member and said second holder member are aligned with each other, said inner spindle is movable relative to said first hollow part between an unlocked position in which said first holder member and said second holder member are movable relative to each other and a locked position in which said first holder member and said second holder member are locked against relative movement.

6. The holder according to claim 5 wherein said inner spindle is biased to said unlocked position.

7. The holder according to claim 5 wherein said inner spindle is movable between said locked position and said unlocked position by rotation.

8. The holder according to claim 4 wherein said inner spindle is movable axially relative to said second hollow part.

9. The holder according to claim 1 wherein said first holder member includes two perpendicular slots through two adjacent rims.

10. The holder according to claim 9 wherein each of said slots is fixedly engaged with a strip of material extending above a major surface of said first holder member.

11. The holder according to claim 10 wherein said second holder member includes two perpendicular slots for receiving at least part of said strips of material.

12. The holder according to claim 1 wherein one corner of said holder is chamfered.

13. The holder according to claim 1 wherein when said sheet of metal is held between said first holder member and said second holder member, at least part of said second major surface of said sheet of metal is exposed to the outside environment.
